(19) United States
(12) Patent Application Publication
(10) Pub. No.: US 2026/0118957 A1
(43) Pub. Date: Apr. 30, 2026

(54) METHOD AND APPARATUS FOR ESTABLISHING COMMUNICATION

(71) Applicant: Samsung Electronics Co., Ltd., Suwon-si (KR)

(72) Inventors: Hyunkee MIN, Suwon-si (KR); Doosuk KANG, Suwon-si (KR); Choonkyoung MOON, Suwon-si (KR); Mingyu LEE, Suwon-si (KR); Bokun CHOI, Suwon-si (KR)

(21) Appl. No.: 19/430,863

(22) Filed: Dec. 23, 2025

Related U.S. Application Data
(63) Continuation of application No. PCT/KR2024/008196, filed on Jun. 14, 2024.

(30) Foreign Application Priority Data
Jul. 13, 2023 (KR) 10-2023-0091046
Aug. 25, 2023 (KR) 10-2023-0112069

(51) Int. Cl. G06F 3/01; G06V 20/20; H04W 12/06; H04W 76/14

(52) U.S. Cl. CPC G06F 3/013; G06V 20/20; H04W 12/06; H04W 76/14

(57) ABSTRACT

An electronic device is provided. The electronic device includes a vision sensor, a communication module, memory, including one or more storage media, storing instructions, and at least one processor communicatively coupled to the vision sensor, the communication module, and the memory, wherein the instructions, when executed by the at least one processor individually or collectively, cause the electronic device to, based on detecting an external device in a viewing region of a user for a threshold time, determine a reference distance between the external device and the electronic device, determine at least one candidate device, determine a candidate distance between a corresponding candidate device and the electronic device by using ranging of the communication module, based on a difference between the reference distance and each candidate distance, determine the external device among the at least one candidate device, and establish communication with the external device by using a device identifier.

### CROSS-REFERENCE TO RELATED APPLICATION(S)

This application is a continuation application, claiming priority under 35 U.S.C. § 365(c), of an International application No. PCT/KR2024/008196, filed on Jun. 14, 2024, which is based on and claims the benefit of a Korean patent application number 10-2023-0091046, filed on Jul. 13, 2023, in the Korean Intellectual Property Office, and of a Korean patent application number 10-2023-0112069, filed on Aug. 25, 2023, in the Korean Intellectual Property Office, the disclosure of each of which is incorporated by reference herein in its entirety.

### BACKGROUND

### 1. Field

The disclosure relates to a technology for establishing communication with an external device.

### 2. Description of Related Art

Recently, virtual reality (VR), augmented reality (AR), and mixed reality (MR) technologies utilizing computer graphics technology have been developed. At this time, VR technology refers to technology that uses a computer to build a virtual space that does not exist in the real world and then makes a user feel the virtual space like reality, and AR or MR technology refers to technology that adds computer-generated information to the real world, that is, technology that combines the real world and a virtual world to allow real-time interaction with a user.

Among these technologies, AR and MR technologies are utilized in conjunction with technologies in various fields (e.g., broadcast technology, medical technology, game technology, or the like). Representative examples of integrating the AR technology and using the AR technology in the broadcast technology field are a smoothly changing weather map in front of a weather caster who delivers a weather forecast on television (TV) or an advertisement image, which does not exist in a stadium, inserted into a screen in a sports broadcast and broadcasted as if the advertisement image is real.

A representative service for providing a user with AR or MR is the “metaverse”. The metaverse is a compound word of ‘meta’ meaning virtual or abstract and ‘universe’ meaning a world, which refers to three-dimensional virtual reality. The metaverse is a more advanced concept than a typical virtual reality environment and provides an AR environment which absorbs virtual reality, such as a web and the Internet, in the real world.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a technology for establishing communication with an external device.

Additional aspects will be set forth in part in the description which follows and, in part, will be apparent from the description, or may be learned by practice of the presented embodiments.

In accordance with an aspect of the disclosure, an electronic device is provided. The electronic device includes a vision sensor, a communication module, memory, including one or more storage media, storing instructions, and at least one processor communicatively coupled to the vision sensor, the communication module, and the memory, wherein the instructions, when executed by the at least one processor individually or collectively, cause the electronic device to determine, using the vision sensor, a reference distance between an external device and the electronic device, based on detecting the external device in a viewing region of a user for a threshold time, determine, based on a category of the external device, at least one candidate device from among devices capable of establishing communication with the electronic device, determine, for each of the at least one determined candidate device, a candidate distance between a corresponding candidate device and the electronic device using ranging of the communication module between a corresponding candidate device and the electronic device, determine, based on a difference between the reference distance and each candidate distance, the external device from among the at least one candidate device, and establish communication with the external device using a device identifier of the external device, which is received from the determined external device.

In accordance with another aspect of the disclosure, a method, performed by an electronic device, is provided. The method includes determining, using a vision sensor, a reference distance between an external device and the electronic device, based on detecting the external device in a viewing region of a user for a threshold time, determining, based on a category of the external device, at least one candidate device from among devices capable of establishing communication with the electronic device, determining, for each of the at least one determined candidate device, a candidate distance between a corresponding candidate device and the electronic device using ranging of a communication module between a corresponding candidate device and the electronic device, determining, based on a difference between the reference distance and each candidate distance, the external device from among the at least one candidate device, and establishing communication with the external device using a device identifier of the external device, which is received from the determined external device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include determining, using a vision sensor, a reference distance between an external device and the electronic device, based on detecting the external device in a viewing region of a user for a threshold time, determining, based on a category of the external device, at least one candidate device from among devices capable of establishing communication with the electronic device, determining, for each of the at least one determined candidate device, a candidate distance between a corresponding candidate device and the electronic device using ranging of a communication module between a corresponding candidate device and the electronic device, determining, based on a difference between the reference distance and each candidate distance, the external device from among the at least one candidate device, and establishing communication with the external device using a device identifier of the external device, which is received from the determined external device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of an electronic device according to an embodiment of the disclosure;

FIG. 2 illustrates an optical see-through (OST) device according to an embodiment of the disclosure;

FIG. 3 illustrates an optical system of an eye-tracking (ET) camera, a transparent member, and a display according to an embodiment of the disclosure;

FIGS. 4A and 4B are diagrams illustrating a front view and a rear view of an electronic device according to various embodiments of the disclosure.

FIG. 5 illustrates a construction of a virtual space and an input from and an output to a user in a virtual space according to an embodiment of the disclosure;

FIG. 6 is a diagram illustrating establishing communication with an external device according to an embodiment of the disclosure;

FIG. 7 is a flowchart illustrating determining an external device from among at least one candidate device according to an embodiment of the disclosure;

FIG. 8A is a flowchart illustrating an electronic device operates as a central device in a discovery operation according to an embodiment of the disclosure;

FIG. 8B is a flowchart illustrating an electronic device operates as a peripheral device in a discovery operation according to an embodiment of the disclosure;

FIG. 9 is a diagram illustrating an electronic device uses a gaze vector and a candidate vector for establishing communication with an external device according to an embodiment of the disclosure;

FIG. 10 is a flowchart illustrating an electronic device performs authentication for an external device according to an embodiment of the disclosure;

FIG. 11 is a flowchart illustrating determining an external device using probability scores for a plurality of categories for a category of the external device according to an embodiment of the disclosure;

FIG. 12 is a flowchart illustrating an electronic device determines a target communication module when a plurality of communication modules is available for ranging between the electronic device and a candidate device according to an embodiment of the disclosure; and

FIG. 13 is a diagram illustrating a feedback interface for at least one candidate device and external devices, provided by an electronic device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

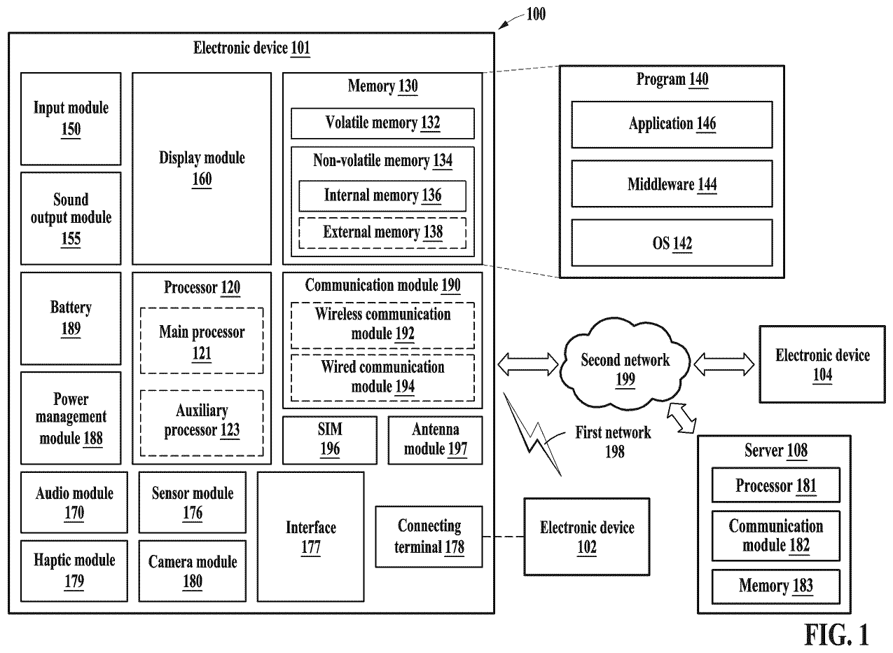

FIG. 1 is a block diagram illustrating a configuration of an electronic device according to an embodiment of the disclosure.

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added to the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120 and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an ISP or a CP) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 (e.g., a display) may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150 or output the sound via the sound output module 155 or an external electronic device (e.g., the external electronic device 102) (e.g., a speaker or headphone) directly or wirelessly coupled with the electronic device 101.

The sensor module 176 may detect an operational state (e.g., power or temperature) of the electronic device 101 or an environmental state (e.g., a state of a user) external to the electronic device 101 and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly or wirelessly. According to an embodiment of the disclosure, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, ISPs, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip) or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mm Wave antenna module may include a PCB, an RFIC disposed on a first surface (e.g., the bottom surface) of the PCB, or adjacent to the first surface and capable of supporting a designated high-frequency band (e.g., the mm Wave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199.

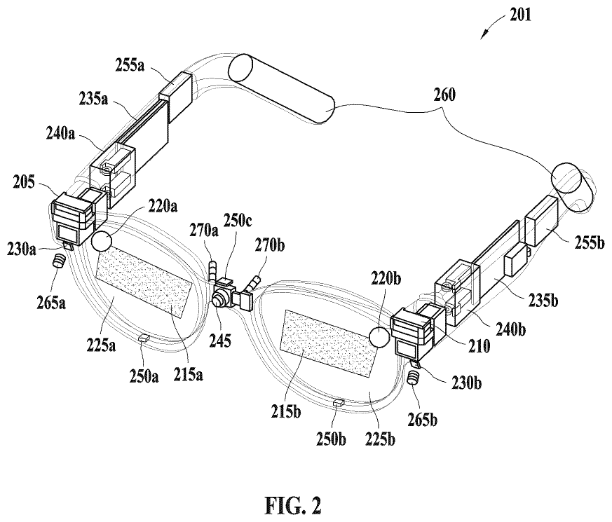

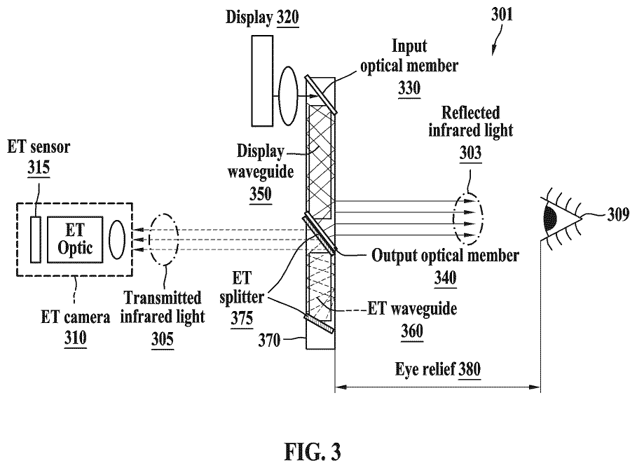

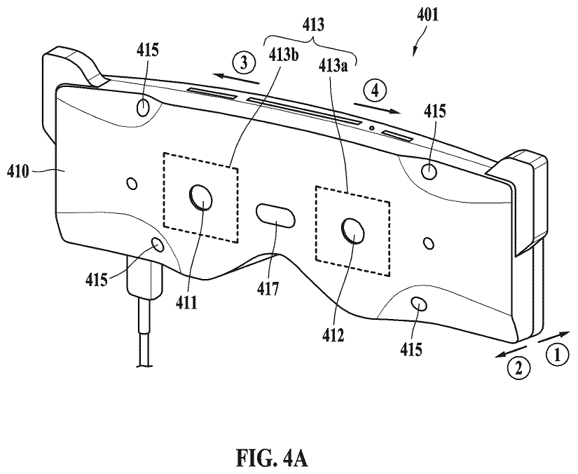

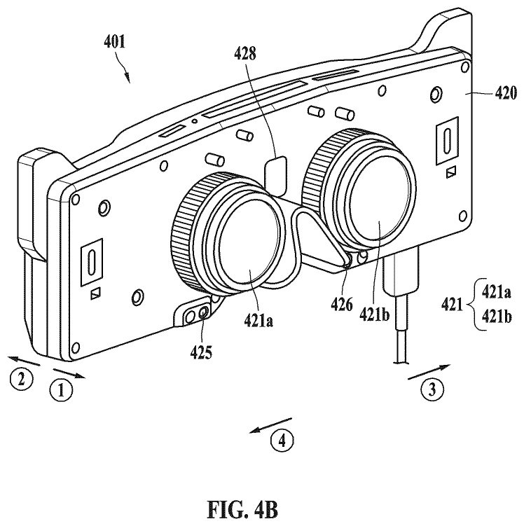

Each of the external electronic devices 102 and 103, and the server 108 may be a device of the same type as or a different type from the electronic device 101. According to an embodiment of the disclosure, all or some of operations to be executed by the electronic device 101 may be executed at one or more external electronic devices (e.g., the external electronic devices 102 and 103, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request and may transfer an outcome of the performing to the electronic device 101. The electronic device 101 may provide the outcome, with or without further processing of the outcome, as at least part of a reply to the request. In the disclosure, an example in which the electronic device 101 is an augmented reality (AR) device (e.g., an electronic device 201 of FIG. 2, an electronic device 301 of FIG. 3, or an electronic device 401 of FIGS. 4A and 4B), and the server 108 among the external electronic devices 102 and 103, and the server 108 transmits, to the electronic device 101, a result of executing a virtual space and an additional function or service associated with the virtual space will be mainly described.

The server 108 may include a processor 181, a communication module 182, and memory 183. The processor 181, the communication module 182, and the memory 183 may be similarly configured to the processor 120, the communication module 190, and the memory 130 of the electronic device 101. For example, the processor 181 may provide a virtual space and an interaction between users in the virtual space by executing instructions stored in the memory 183. The processor 181 may generate at least one of visual information, auditory information, or tactile information of the virtual space and objects in the virtual space. For example, as the visual information, the processor 181 may generate rendered data (e.g., visual rendered data) obtained by rendering an appearance (e.g., a shape, size, color, or texture) of the virtual space and an appearance (e.g., a shape, size, color, or texture) of an object positioned in the virtual space. Additionally, the processor 181 may generate rendered data obtained by rendering changes (e.g., changes in the appearance of an object, sound generation, or tactile sensation generation) based on at least one of an interaction between objects (e.g., physical objects, virtual objects, or avatar objects) in the virtual space, or a user input to objects (e.g., physical objects, virtual objects, or avatar objects). The communication module 182 may establish communication with a first electronic device (e.g., the electronic device 101) of a user and a second electronic device (e.g., the external electronic device 102) of another user. The communication module 182 may transmit at least one of the visual information, tactile information, or auditory information described above to the first electronic device and the second electronic device. For example, the communication module 182 may transmit rendered data.

For example, after rendering content data executed by an application, the server 108 may transmit the content data to the electronic device 101, and the electronic device 101 receiving the data may output the content data to the display module 160. If the electronic device 101 detects a user movement through an inertial measurement unit (IMU) sensor or the like, the processor 120 of the electronic device 101 may correct the rendered data received from the external electronic device 102 based on the movement information and output the corrected rendered data to the display module 160. Alternatively, the processor may transmit the movement information to the server 108 to request rendering such that screen data is updated accordingly. However, embodiments are not limited thereto, and the rendering may be performed by various types of external electronic devices (e.g., 102 and 103), such as a smartphone or a case device for storing and charging the electronic device 101. The rendering data corresponding to the virtual space generated by the external electronic devices 102 and 103 may be provided to the electronic device 101. In another example, the electronic device 101 may receive virtual spatial information (e.g., vertex coordinates, texture, and color defining a virtual space) and object information (e.g., vertex coordinates, texture, and color defining an appearance of an object) from the server 108 and perform rendering by itself based on the received data.

FIG. 2 illustrates an optical see-through (OST) device according to an embodiment of the disclosure.

Referring to FIG. 2, an electronic device 201 may include at least one of a display (e.g., the display module 160 of FIG. 1), a vision sensor, light sources 230a and 230b, an optical element, or a substrate. The electronic device 201 including a transparent display and providing an image through the transparent display may be referred to as an OST device.

For example, the display may include a liquid crystal display (LCD), a digital mirror device (DMD), a liquid crystal on silicon (LCOS), an organic light-emitting diode (OLED), or a micro light-emitting diode (micro-LED).

In an embodiment of the disclosure, when the display is one of an LCD, a DMD, or an LCOS, the electronic device 201 may include the light sources 230a and 230b configured to emit light to a screen output area (e.g., screen display portions 215a and 215b) of the display. In another embodiment of the disclosure, when the display is capable of generating light by itself, for example, when the display is either the OLED or the micro-LED, the electronic device 201 may provide a virtual image with a relatively high quality to a user even though the separate light sources 230a and 230b are not included. In an embodiment of the disclosure, when the display is implemented as an OLED or a micro-LED, the light sources 230a and 230b may be unnecessary, which may lead to lightening of the electronic device 201.

The electronic device 201 may include the display, a first transparent member 225a, and/or a second transparent member 225b, and the user may use the electronic device 201 while wearing the electronic device 201 on the face of the user. The first transparent member 225a and/or the second transparent member 225b may be formed of a glass plate, a plastic plate, or a polymer, and may be transparently or translucently formed. According to an embodiment of the disclosure, the first transparent member 225a may be disposed to face the right eye of the user, and the second transparent member 225b may be disposed to face the left eye of the user. The display may include a first display 205 configured to output a first image (e.g., a right image) corresponding to the first transparent member 225a and a second display 210 configured to output a second image (e.g., a left image) corresponding to the second transparent member 225b. According to an embodiment of the disclosure, when each display is transparent, the displays and the transparent members may be disposed to face the eyes of the user to configure the screen display portions 215a and 215b.

In an embodiment of the disclosure, a light path of light emitted from the displays 205 and 210 may be guided by a waveguide through input optical members 220a and 220b. Light moving into the waveguide may be guided toward the eyes of a user through an output optical member (e.g., an output optical member 340 of FIG. 3). The screen display portions 215a and 215b may be determined based on light emitted toward the eyes of the user.

For example, the light emitted from the displays 205 and 210 may be reflected from a grating region of the waveguide formed in the input optical members 220a and 220b and the screen display portions 215a and 215b, and may be transmitted to the eyes of the user.

The optical element may include at least one of a lens or an optical waveguide.

The lens may adjust a focus such that a screen output to the display may be visible to the eyes of the user. The lens may include, for example, at least one of a Fresnel lens, a pancake lens, or a multichannel lens.

The optical waveguide may transmit an image ray generated by the display to the eyes of the user. For example, the image rays may represent rays of light emitted by the light sources 230a and 230b, that pass through the screen output area of the display. The optical waveguide may be formed of glass, plastic, or polymer. The optical waveguide may have a nanopattern formed on one inside surface or one outside surface, for example, a grating structure of a polygonal or curved shape. A structure of the optical waveguide is described below with reference to FIG. 3.

The vision sensor may include at least one of a camera sensor or a depth sensor.

First cameras 265a and 265b may be recognition cameras and may be cameras used for 3 degrees of freedom (DoF) or 6DoF head tracking, hand detection, hand tracking, and space recognition. The first cameras 265a and 265b may mainly include a global shutter (GS) camera. Since a stereo camera is required for head tracking and space recognition, the first cameras 265a and 265b may include two or more GS cameras. A GS camera may have a more excellent performance compared to a rolling shutter (RS) camera, in terms of detecting and tracking a fine movement, such as a quick movement of a hand or a finger. For example, the GS camera may have a low image blur. The first cameras 265a and 265b may capture image data used for a simultaneous localization and mapping (SLAM) function through depth capturing and space recognition for 6DoF. In addition, a user gesture recognition function may be performed based on image data captured by the first cameras 265a and 265b.

The first and second ET cameras 270a and 270b, which are eye tracking (ET) cameras, may be used to capture image data for detecting and tracking the pupils of the user. The first and second ET cameras 270a and 270b are described with reference to FIG. 3 below.

A third camera 245 may be a camera for image capturing. The third camera 245 may include a high-resolution (HR) camera to capture an HR image or a photo video (PV) image. The third camera 245 may include a color camera having functions for obtaining a high-quality image, such as, an automatic focus (AF) function and an optical image stabilizer (OIS). The third camera 245 may be a GS camera or an RS camera.

A fourth camera (e.g., face recognition cameras 425 and 426 of FIG. 4B below) is a face recognition camera, and a face tracking (FT) camera may be used to detect and track facial expressions of the user.

A depth sensor (not shown) may be a sensor configured to detect information for determining a distance to an object such as time of flight (TOF). The TOF is technology for measuring a distance to an object using a signal (e.g., a near infrared ray, ultrasound, laser, or the like). A TOF-based depth sensor may transmit a signal from a transmitter and measure the signal by a receiver, thereby measuring a TOF of the signal.

The light sources 230a and 230b (e.g., illumination modules) may include an element (e.g., an LED) configured to emit light of various wavelengths. The illumination module may be attached to various positions depending on the purpose of use. In an example of use, a first illumination module (e.g., an LED element), attached around a frame of an AR glasses device, may emit light for assisting gaze detection when tracking a movement of the eyes with an ET camera. The first illumination module may include, for example, an IR LED of an infrared wavelength. In another example of use, a second illumination module (e.g., an LED element) may be attached around hinges 240a and 240b connecting a frame and a temple or attached in proximity to a camera mounted around a bridge connecting the frame. The second illumination module may emit light for supplementing ambient brightness when the camera captures an image. When it is not easy to detect a subject in a dark environment, the second illumination module may emit light.

Substrates 235a and 235b (e.g., PCBs) may support the components described above.

The PCB may be disposed on temples of the glasses. A flexible PCB (FPCB) may transmit an electrical signal to each module (e.g., a camera, a display, an audio module, and a sensor module) and another PCB. According to an embodiment of the disclosure, at least one PCB may include a first substrate, a second substrate, and an interposer disposed between the first substrate and the second substrate. In another example, the PCB may be disposed at the center of a set. An electrical signal may be transmitted to each module and the other PCB through the FPCB.

The other components may include, for example, at least one of a plurality of microphones (e.g., a first microphone 250a, a second microphone 250b, and a third microphone 250c), a plurality of speakers (e.g., a first speaker 255a and a second speaker 255b), a battery 260, an antenna, or a sensor (e.g., an acceleration sensor, a gyro sensor, a touch sensor, or the like).

FIG. 3 illustrates an optical system of an ET camera, a transparent member, and a display, according to an embodiment of the disclosure.

FIG. 3 is a diagram illustrating an operation of an ET camera included in an electronic device, according to an embodiment of the disclosure. FIG. 3 illustrates an operation in which an ET camera 310 (e.g., a first ET camera 270a and a second ET camera 270b of FIG. 2) of the electronic device 301 according to an embodiment tracks an eye 309 of the user, that is, a gaze of the user, using light (e.g., infrared light) output from a display 320 (e.g., the first display 205 and the second display 210 of FIG. 2).

A second camera (e.g., the first and second ET cameras 270a and 270b of FIG. 2) may be the ET camera 310 that collects information for positioning the center of a virtual image projected onto the electronic device 301 according to a direction at which pupils of a wearer of the electronic device 301 gaze. The second camera may also include a GS camera to detect the pupils and track the rapid movement of the pupils. The ET cameras may be installed for the right eye and the left eye, and the ET cameras having the same camera performance and specifications may be used. The ET camera 310 may include an ET sensor 315. The ET sensor 315 may be included inside the ET camera 310. The infrared light output from the display 320 may be transmitted as reflected infrared light 303 to the eye 309 of the user by a half mirror. The ET sensor 315 may detect transmitted infrared light 305 that is generated when the reflected infrared light 303 is reflected from the eye 309 of the user. The ET camera 310 may track the eye 309 of the user, that is, the gaze of the user, based on the result of the detection by the ET sensor 315.

The display 320 may include a plurality of visible light pixels and a plurality of infrared pixels. The visible light pixels may include R, G, and B pixels. The visible light pixels may output visible light corresponding to a virtual object image. The infrared pixels may output infrared light. The display 320 may include, for example, micro LEDs or OLEDs.

A display waveguide 350 and an ET waveguide 360 may be included in a transparent member 370 (e.g., the first transparent member 225a and the second transparent member 225b of FIG. 2). The transparent member 370 may be formed as, for example, a glass plate, a plastic plate, or a polymer and may be transparently or translucently formed. The transparent member 370 may be disposed to face an eye of a user. In this case, a distance between the transparent member 370 and the eye 309 of the user may be referred to as an “eye relief” 380.

The transparent member 370 may include the display waveguide 350 and the ET waveguide 360. The transparent member 370 may include an input optical member 330 and an output optical member 340. In addition, the transparent member 370 may include an ET splitter 375 that splits input light into several waveguides.

According to an embodiment of the disclosure, light incident to one end of the display waveguide 350 may be propagated inside the display waveguide 350 by a nanopattern and may be provided to a user. In addition, the display waveguide 350 formed of a free-form prism may provide incident light as an image ray to the user through a reflection mirror. The display waveguide 350 may include at least one of a diffractive element (e.g., a diffractive optical element (DOE) or a holographic optical element (HOE)) or a reflective element (e.g., a reflection mirror). The display waveguide 350 may guide display light (e.g., an image ray) emitted from the light source to the eyes of the user, using at least one of the diffractive element or the reflective element included in the display waveguide 350. For reference, although FIG. 3 illustrates that the output optical member 340 is separate from the ET waveguide 360, the output optical member 340 may be included in the ET waveguide 360.

According to various embodiments of the disclosure, the diffractive element may include the input optical member 330 and the output optical member 340. For example, the input optical member 330 may refer, for example, to an “input grating region.” The output optical member 340 may refer, for example, to an “output grating region”. The input grating region may serve as an input end that diffracts (or reflects) light, that is output from a micro-LED, to transmit the light to a transparent member (e.g., a first transparent member and a second transparent member) of a screen display portion. The output grating region may serve as an exit that diffracts (or reflects), to the eyes of the user, the light transmitted to the transparent member (e.g., the first transparent member and the second transparent member) of a waveguide.

According to various embodiments of the disclosure, the reflective element may include a total internal reflection (TIR) waveguide or a TIR optical element for TIR. For example, TIR, which is one scheme for inducing light, may form an angle of incidence such that light (e.g., a virtual image) entering through the input grating region is completely reflected from one surface (e.g., a specific surface) of the waveguide, to completely transmit the light to the output grating region.

In an embodiment of the disclosure, a light path of the light emitted from the display 320 may be guided by the waveguide through the input optical member 330. The light moving the inside of the waveguide may be guided toward the eyes of the user through the output optical member 340. The screen display portion may be determined based on the light emitted toward the eyes of the user.

FIGS. 4A and 4B are diagrams illustrating a front view and a rear view of an electronic device according to various embodiments of the disclosure. FIG. 4A may be an appearance of an electronic device 401 viewed in a first direction \textcircled{1}, and FIG. 4B may be an appearance of the electronic device 401 viewed in a second direction \textcircled{2}. When a user wears the electronic device 401, the appearance viewed by the user's eyes may be illustrated in FIG. 4B.

Referring to FIG. 4A, according to various embodiments of the disclosure, the electronic device 401 (e.g., the electronic device 101 of FIG. 1, the electronic device 201 of FIG. 2, or the electronic device 301 of FIG. 3) may provide a service providing an extended reality (XR) experience to the user. For example, the XR or XR service may be defined as a service that collectively refers to virtual reality (VR), AR, and/or mixed reality (MR).

According to an embodiment of the disclosure, the electronic device 401 may refer to a head-mounted device or head-mounted display (HMD) worn on the head of the user but may be provided in the form of at least one of glasses, goggles, a helmet, or a hat. The electronic device 401 may include some types, such as an OST type configured such that, when being worn, external light reaches the eyes of the user through glasses or a video see-through (VST) type configured such that, when being worn, light emitted from a display reaches the eyes of the user but external light is blocked not to reach the eyes of the user.

According to an embodiment of the disclosure, the electronic device 401 may be worn on the head of the user and provide images related to an XR service to the user. For example, the electronic device 401 may provide XR content (hereinafter, also referred to as an XR content image) output such that at least one virtual object is visible overlapping in a display area or an area determined to be a field of view (FOV) of the user. According to an embodiment of the disclosure, the XR content may refer to an image related to a real space obtained through a camera (e.g., an image-capturing camera) or an image or video in which at least one virtual object is added to a virtual space. According to an embodiment of the disclosure, the electronic device 401 may provide XR content based on a function being performed by the electronic device 401 and/or a function being performed by at least one or more external electronic devices of external electronic devices (e.g., the external electronic devices 102 and 104 of FIG. 1 and the server 108 of FIG. 1).

According to an embodiment of the disclosure, the electronic device 401 may be at least partially controlled by an external electronic device (e.g., the external electronic device 102 or 104 of FIG. 1), or may perform at least one function under the control of the external electronic device or perform at least one function independently.

Referring to FIG. 4A, a vision sensor may be disposed on a first surface of a housing of a main body 410 of the electronic device 401. The vision sensor may include cameras (e.g., second function cameras 411 and 412, and first function cameras 415) and/or a depth sensor 417 for obtaining information related to the surrounding environment of the electronic device 401.

In an embodiment of the disclosure, the second function cameras 411 and 412 may obtain images related to the surrounding environment of the electronic device 401. With a wearable electronic device worn by the user, the first function cameras 415 may obtain images. The first function cameras 415 may be used for hand detection and tracking, and recognition of gestures (e.g., hand gestures) of the user. The first function cameras 415 may be used for 3DoF and 6DoF head tracking, position (space, environment) recognition, and/or movement recognition. In an embodiment of the disclosure, the second function cameras 411 and 412 may also be used for hand detection and tracking, and the recognition of user gestures.

In an embodiment of the disclosure, the depth sensor 417 may be configured to transmit a signal and receive a signal reflected from an object and may be used to determine a distance to an object based on the TOF. Alternatively of or additionally, the cameras 411, 412, and 415 may determine the distance to the object in place of the depth sensor 417.

Referring to FIG. 4B, the face recognition cameras 425 and 426 and/or a display 421 (and/or a lens) may be disposed on a second surface 420 of the housing of the main body 410.

In an embodiment of the disclosure, the face recognition cameras 425 and 426 adjacent to a display may be used to recognize the face of the user or may recognize and/or track both eyes of the user.

In an embodiment of the disclosure, the display 421 (and/or a lens) may be disposed on the second surface 420 of the electronic device 401. In an embodiment of the disclosure, the electronic device 401 may not include some of the plurality of cameras 415. Although not shown in FIGS. 4A and 4B, the electronic device 401 may further include at least one of the components shown in FIG. 2.

According to an embodiment of the disclosure, the electronic device 401 may include the main body 410 on which at least some of the components of FIG. 1 are mounted, the display 421 (e.g., the display module 160 of FIG. 1) disposed in the first direction \textcircled{1} of the main body 410, the first function cameras 415 (e.g., recognition cameras) disposed in the second direction \textcircled{2} of the main body 410, the second function cameras 411 and 412 (e.g., image-capturing cameras) disposed in the second direction \textcircled{2}, a third function camera 428 (e.g., an ET camera) disposed in the first direction \textcircled{1}, fourth function cameras (e.g., the face recognition cameras 425 and 426) disposed in the first direction \textcircled{1}, the depth sensor 417 disposed in the second direction \textcircled{2}, and a touch sensor 413 disposed in the second direction \textcircled{2}. Although not shown in the drawings, the main body 410 may include memory (e.g., the memory 130 of FIG. 1) and a processor (e.g., the processor 120 of FIG. 1) therein and may further include other components shown in FIG. 1.

According to an embodiment of the disclosure, the display 421 may include an LCD, a DMD, an LCOS device, an OLED, or a micro-LED.

In an embodiment of the disclosure, when the display 421 is one of an LCD, a DMD, or an LCOS device, the electronic device 401 may include a light source that emits light to a screen output area of the display 421. In another embodiment of the disclosure, when the display 421 is capable of generating light by itself, for example, when the electronic device 401 is formed of one of an OLED or a micro-LED, the electronic device 401 may provide an XR content image with a relatively high quality to the user, even though a separate light source is not included. In an embodiment of the disclosure, when the display 421 is implemented as an OLED or a micro-LED, a light source may be unnecessary, which may lead to lightening of the electronic device 401.

According to an embodiment of the disclosure, the display 421 may include a first transparent member 421a and/or a second transparent member 421b. The user may use the electronic device 401 with the electronic device 401 worn on the face. The first transparent member 421a and/or the second transparent member 421b may be formed of a glass plate, a plastic plate, or a polymer and may be transparently or translucently formed. According to an embodiment of the disclosure, the first transparent member 421a may be disposed to face the left eye of the user in a fourth direction \textcircled{4}, and the second transparent member 421b may be disposed to face the right eye of the user in a third direction \textcircled{3}. According to various embodiments of the disclosure, when the display 421 is transparent, the display 421 may be disposed at a position facing the eyes of the user to form a display area.

According to an embodiment of the disclosure, the display 421 may include a lens including a transparent waveguide. The lens may serve to adjust the focus such that a screen (e.g., an XR content image) output to the display 421 is to be viewed by the eyes of the user. For example, light emitted from a display panel may pass through the lens and be transmitted to the user through the waveguide formed within the lens. The lens may include, for example, a Fresnel lens, a pancake lens, or a multichannel lens.

An optical waveguide (e.g., a waveguide) may serve to transmit a light source generated by the display 421 to the eyes of the user. The optical waveguide may be formed of glass, plastic, or a polymer and may have a nanopattern formed on a portion of an inner or outer surface, for example, a grating structure of a polygonal or curved shape. According to an embodiment of the disclosure, light incident to one end of the optical waveguide, that is, an output image of the display 421 may be propagated inside the optical waveguide to be provided to the user. In addition, the optical waveguide formed of a free-form prism may provide the incident light to the user through a reflection mirror. The optical waveguide may include at least one of diffraction elements (e.g., a DOE and an HOE) or at least one of reflective elements (e.g., a reflection mirror). The optical waveguide may guide an image output from the display 421 to the eyes of the user using the at least one diffractive element or reflective element included in the optical waveguide.

According to an embodiment of the disclosure, the diffractive element may include an input optical member/output optical member (not shown). For example, the input optical member may refer to an input grating region, and the output optical member (not shown) may refer to an output grating region. The input grating region may serve as an input end that diffracts (or reflects) light output from a light source (e.g., a micro-LED) to transmit the light to a transparent member (e.g., the first transparent member 421a and the second transparent member 421b) of the display area. The output grating region may serve as an exit that diffracts (or reflects) the light transmitted to the transparent member (e.g., the first transparent member and the second transparent member) of the optical waveguide to the eyes of the user.

According to various embodiments of the disclosure, the reflective element may include a TIR optical element or a TIR waveguide for TIR. For example, TIR, which is a scheme for guiding light, may generate an angle of incidence such that light (e.g., a virtual image) input through the input grating region is substantially completely reflected from one surface (e.g., a specific surface) of the optical waveguide, to completely transmit the light to the output grating region.

In an embodiment of the disclosure, the light emitted from the display 421 may be guided to an optical path to the waveguide through the input optical member. The light traveling inside the optical waveguide may be guided toward the eyes of the user through the output optical member. The display area may be determined based on the light emitted in the direction of the eyes.

According to an embodiment of the disclosure, the electronic device 401 may include a plurality of cameras. For example, the cameras may include the first function cameras 415 (e.g., recognition cameras) disposed in the second direction \textcircled{2} of the main body 410, the second function cameras 411 and 412 (e.g., image-capturing cameras) disposed in the second direction \textcircled{2}, the third function camera 428 (e.g., an ET camera) disposed in the first direction \textcircled{1}, and/or the fourth function cameras (e.g., the face recognition cameras 425 and 426) disposed in the first direction \textcircled{1}, and may further include other function cameras (not shown).

The first function cameras 415 (e.g., the recognition cameras) may be used for a function of detecting a movement of the user or recognizing a gesture of the user. The first function cameras 415 may support at least one of head tracking, hand detection and hand tracking, and space recognition. For example, the first function cameras 415 may mainly use a GS camera having excellent performance compared to an RS camera to detect and track fine gestures or movements of hands and fingers and may be configured as a stereo camera including two or more GS cameras for head tracking and space recognition. The first function cameras 415 may perform functions, such as, 6DoF space recognition, and a SLAM function for recognizing information (e.g., a position and/or direction) associated with a surrounding space through depth imaging.

The second function cameras 411 and 412 (e.g., the image-capturing cameras) may be used to capture images of the outside, generate an image or video corresponding to the outside, and transmit the image or video to a processor (e.g., the processor 120 of FIG. 1). The processor may display the image provided from the second function cameras 411 and 412 on the display 421. The second function cameras 411 and 412 may also be referred to as HR or PV cameras and may include an HR camera. For example, the second function cameras 411 and 412 may include color cameras equipped with a function for obtaining high-quality images, such as an AF function and OIS, but are not limited thereto. The second function cameras 411 and 412 may also include a GS camera or an RS camera.

The third function camera 428 (e.g., the ET camera) may be disposed on the display 421 (or inside the main body) such that camera lenses face the eyes of the user when the user wears the electronic device 401. The third function camera 428 may be used for detecting and tracking the pupils (e.g., ET). The processor may verify a gaze direction by tracking movements of the left eye and the right eye of the user in an image received from the third function camera 428. By tracking the positions of the pupils in the image, the processor may be configured such that the center of an XR content image displayed on the display area is positioned according to a direction in which the pupils are gazing. For example, the third function camera 428 may use a GS camera to detect the pupils and track the movements of the pupils. The third function camera 428 may be installed for each of the left eye and the right eye and may have the same camera performance and specifications.

The fourth function cameras (e.g., the face recognition cameras 425 and 426) may be used to detect and track a facial expression of the user (e.g., FT) when the user wears the electronic device 401.

According to an embodiment of the disclosure, the electronic device 401 may include a lighting unit (e.g., LED) (not shown) as an auxiliary means for cameras. For example, the third function camera 428 may use a lighting unit included in a display as an auxiliary means for facilitating gaze detection when tracking eye movements, to direct emitted light (e.g., IR LED of an IR wavelength) toward both eyes of the user. In another example, the second function cameras 411 and 412 may further include a lighting unit (e.g., a flash) as an auxiliary means for supplementing surrounding brightness when capturing an image of the outside.

According to an embodiment of the disclosure, the depth sensor 417 (or a depth camera) may be used to verify a distance to an object (e.g., a target) through, for example, TOF. TOF, which is technology for measuring a distance to an object using a signal (e.g., near-infrared rays, ultrasound, or laser), may transmit a signal from a transmitter and then measure the signal by a receiver, and may measure a distance to an object based on the TOF of the signal.

According to an embodiment of the disclosure, the touch sensor 413 may be disposed in the second direction \textcircled{2} of the main body 410. For example, when the user wears the electronic device 401, the eyes of the user may view in the first direction \textcircled{1} of the main body. The touch sensor 413 may be implemented as a single type or a left/right separated type based on the shape of the main body 410 but is not limited thereto. For example, in a case in which the touch sensor 413 is implemented as the left/right separated type as shown in FIG. 4A, when the user wears the electronic device 401, a first touch sensor 413a may be disposed at a position corresponding to the left eye of the user in the fourth direction \textcircled{4}, and a second touch sensor 413b may be disposed at a position corresponding to the right eye of the user in the third direction \textcircled{3}.

The touch sensor 413 may recognize a touch input using at least one of, for example, capacitive, resistive, infrared, or ultrasonic method. For example, the touch sensor 413 using the capacitive method may recognize a physical touch (or contact) input or hovering (or proximity) input of an external object. According to some embodiments of the disclosure, the electronic device 401 may use a proximity sensor (not shown) to recognize the proximity to an external object.

According to an embodiment of the disclosure, the touch sensor 413 may have a two-dimensional (2D) surface and transmit, to a processor (e.g., the processor 120 of FIG. 1), touch data (e.g., touch coordinates) of an external object (e.g., a finger of the user) contacting the touch sensor 413. The touch sensor 413 may detect a hovering input of an external object (e.g., a finger of the user) approaching within a first distance away from the touch sensor 413 or detect a touch input contacting the touch sensor 413.

In an embodiment of the disclosure, the touch sensor 413 may provide 2D information about the contact point to the processor 120 as “touch data” when an external object touches the touch sensor 413. The touch data may be described as a “touch mode.” When the external object is positioned within the first distance from the touch sensor 413 (or hovers above a proximity or touch sensor), the touch sensor 413 may provide hovering data about a time point or position of the external object hovering around the touch sensor 413 to the processor 120. The hovering data may also be described as a “hovering mode/proximity mode.”

According to an embodiment of the disclosure, the electronic device 401 may obtain the hovering data using at least one of the touch sensor 413, a proximity sensor (not shown), and/or the depth sensor 417 to generate information about a distance between the touch sensor 413 and an external object, a position, or a time point.

According to an embodiment of the disclosure, the main body 410 may include a processor (e.g., the processor 120 of FIG. 1) and memory (e.g., the memory 130 of FIG. 1) therein.

The memory may store various instructions that may be executed by the processor. The instructions may include control instructions, such as arithmetic and logical operations, data movement, or input/output, which may be recognized by the processor. The memory may include volatile memory (e.g., the volatile memory 132 of FIG. 1) and non-volatile memory (e.g., the non-volatile memory 134 of FIG. 1) to store, temporarily or permanently, various pieces of data.

The processor may be operatively, functionally, and/or electrically connected to each of the components of the electronic device 401 to perform control and/or communication-related computation or data processing of each of the components. The operations performed by the processor may be stored in the memory and, when executed, may be executed by the instructions that cause the processor to operate.

Although there will be no limitation to the computation and data processing functions implemented by the processor on the electronic device 401, a series of operations related to an XR content service function will be described hereinafter. The operations of the processor to be described below may be performed by executing the instructions stored in the memory.

According to an embodiment of the disclosure, the processor may generate a virtual object based on virtual information based on image information. The processor may output a virtual object related to an XR service along with background spatial information through the display 421. For example, the processor may obtain image information by capturing an image related to a real space corresponding to an FOV of the user wearing the electronic device 401 through the second function cameras 411 and 412 or may generate a virtual space of a virtual environment. For example, the processor may perform control to display, on the display 421, XR content (hereinafter, referred to as an XR content screen) that outputs at least one virtual object such that the at least one virtual object is visible overlapping in an FOV area or an area determined to be the FOV of the user.

According to an embodiment of the disclosure, the electronic device 401 may have a form factor to be worn on the head of the user. The electronic device 401 may further include a strap and/or a wearing member to be fixed on the body part of the user. The electronic device 401 may provide a VR, AR, and/or MR-based user experience while being worn on the head of the user.

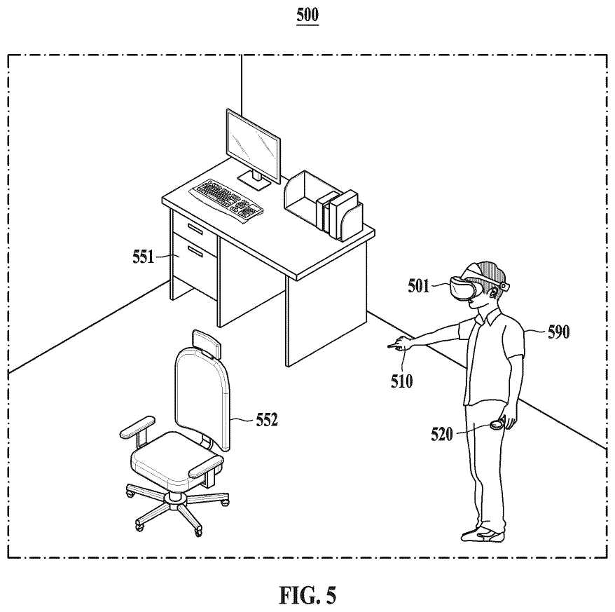

FIG. 5 illustrates a construction of a virtual space and an input from and an output to a user in the virtual space according to an embodiment of the disclosure.

Referring to FIG. 5, an electronic device (e.g., the electronic device 101 of FIG. 1, the electronic device 201 of FIG. 2, the electronic device 301 of FIG. 3, and the electronic device 401 of FIGS. 4A and 4B) may obtain spatial information about a physical space in which sensors are located using the sensors. The spatial information may include a geographic location of the physical space in which the sensors are located, a size of the space, an appearance of the space, a position of a physical object 551 disposed in the space, a size of the physical object 551, an appearance of the physical object 551, and illuminant information. The appearance of the space and the physical object 551 may include at least one of a shape, a texture, or a color of the space and the physical object 551. The illuminant information, which is information about a light source that emits light acting in the physical space, may include at least one of an intensity, a direction, or a color of illumination. The sensors described above may collect information for providing AR. For example, in an AR device shown in FIGS. 2, 3, 4A, and 4B, the sensors may include a camera and a depth sensor. However, the sensors are not limited thereto, and the sensors may further include at least one of an infrared sensor, a depth sensor (e.g., a light detection and ranging (LiDAR) sensor, a radio detection and ranging (radar) sensor, or a stereo camera), a gyro sensor, an acceleration sensor, or a geomagnetic sensor.

An electronic device 501 may collect the spatial information over a plurality of time frames. For example, in each time frame, the electronic device 501 may collect information about a space of a portion belonging to a scene within a sensing range (e.g., an FOV) of a sensor at a position of the electronic device 501 in the physical space. The electronic device 501 may analyze the spatial information of the time frames to track a change (e.g., a position movement or state change) of an object over time. The electronic device 501 may integrally analyze the spatial information collected through the plurality of sensors to obtain integrated spatial information (e.g., an image obtained by spatially stitching scenes around the electronic device 501 in the physical space) of an integrated sensing range of the plurality of sensors.

According to an embodiment of the disclosure, the electronic device 501 may analyze the physical space as three-dimensional (3D) information, using various input signals (e.g., sensing data of a red, green, and blue (RGB) camera, an infrared sensor, a depth sensor, or a stereo camera) of the sensors. For example, the electronic device 501 may analyze at least one of the shape, the size, or the position of the physical space, and the shape, the size, or the position of the physical object 551.

For example, the electronic device 501 may detect an object captured in a scene corresponding to an FOV of a camera, using sensing data (e.g., a captured image) of the camera. The electronic device 501 may determine a label of the physical object 551 (e.g., as information indicating classification of an object, including values indicating a chair, a monitor, or a plant) from a 2D scene image of the camera and an area (e.g., a bounding box) occupied by the physical object 551 in the 2D scene. Accordingly, the electronic device 501 may obtain 2D scene information from a position at which a user 590 is viewing. In addition, the electronic device 501 may also calculate a position of the electronic device 501 in the physical space based on the sensing data of the camera.

The electronic device 501 may obtain position information of the user 590 and depth information of a real space in a viewing direction, using sensing data (e.g., depth data) of a depth sensor. The depth information, which is information indicating a distance from the depth sensor to each point, may be expressed in the form of a depth map. The electronic device 501 may analyze a distance in the unit of each pixel at a 3D position at which the user 590 is viewing.

The electronic device 501 may obtain information including a 3D point cloud and mesh using various pieces of sensing data. The electronic device 501 may obtain a plane, a mesh, or a 3D coordinate point cluster that configures the space by analyzing the physical space. The electronic device 501 may obtain a 3D point cloud representing physical objects based on the information obtained as described above.

The electronic device 501 may obtain information including at least one of 3D position coordinates, 3D shapes, or 3D sizes (e.g., 3D bounding boxes) of the physical objects arranged in the physical space by analyzing the physical space.

Accordingly, the electronic device 501 may obtain physical object information detected in the 3D space and semantic segmentation information about the 3D space. The physical object information may include at least one of a position, an appearance (e.g., a shape, texture, and color), or a size of the physical object 551 in the 3D space. The semantic segmentation information, which is information obtained by semantically segmenting the 3D space into subspaces, may include, for example, information indicating that the 3D space is segmented into an object and a background and information indicating that the background is segmented into a wall, a floor, and a ceiling. As described above, the electronic device 501 may obtain and store 3D information (e.g., spatial information) about the physical object 551 and the physical space. The electronic device 501 may store 3D position information of the user 590 in the space, along with the spatial information.

The electronic device 501 according to an embodiment may construct a virtual space 500 based on the physical positions of the electronic device 501 and/or the user 590. The electronic device 501 may generate the virtual space 500 by referring to the spatial information described above. The electronic device 501 may generate the virtual space 500 of the same scale as the physical space based on the spatial information and arrange objects in the generated virtual space 500. The electronic device 501 may provide a complete VR to the user 590 by outputting an image that substitutes the entire physical space. The electronic device 501 may provide MR or AR by outputting an image that substitutes a portion of the physical space. Although the construction of the virtual space 500 based on the spatial information obtained by the analysis of the physical space is described, the electronic device 501 may also construct the virtual space 500 irrespective of the physical position of the user 590. The virtual space 500 described herein may be a space corresponding to AR or VR and may also be referred to as a metaverse space.

For example, the electronic device 501 may provide a virtual graphic representation that substitutes at least a partial space of the physical space. The electronic device 501, which is an OST-based electronic device, may output the virtual graphic representation overlaid on a screen area corresponding to at least a partial space of a screen display portion. The electronic device 501, which is a VST-based electronic device, may output an image generated by substituting an image area corresponding to at least a partial space in a space image corresponding to a physical space rendered based on the spatial information with a virtual graphic representation. The electronic device 501 may substitute at least a portion of a background in the physical space with a virtual graphic representation, but embodiments are not limited thereto. The electronic device 501 may only additionally arrange a virtual object 552 in the virtual space 500 based on the spatial information, without changing the background.

The electronic device 501 may arrange and output the virtual object 552 in the virtual space 500. The electronic device 501 may set a manipulation area for the virtual object 552 in a space occupied by the virtual object 552 (e.g., a volume corresponding to an appearance of the virtual object 552). The manipulation area may be an area in which a manipulation of the virtual object 552 occurs. In addition, the electronic device 501 may substitute the physical object 551 with the virtual object 552 and output the virtual object 552. The virtual object 552 corresponding to the physical object 551 may have the same or similar shape as or to the corresponding physical object 551. However, embodiments are not limited thereto, and the electronic device 501 may set only the manipulation area in a space occupied by the physical object 551 or at a position corresponding to the physical object 551, without outputting the virtual object 552 that substitutes the physical object 551. For example, the electronic device 501 may transmit, to the user 590, visual information representing the physical object 551 (e.g., light reflected from the physical object 551 or an image obtained by capturing the physical object 551) as it is without a change, and set the manipulation area in the corresponding physical object 551. The manipulation area may be set to have the same shape and volume as the space occupied by the virtual object 552 or the physical object 551 but is not limited thereto. The electronic device 501 may set the manipulation area that is smaller than the space occupied by the virtual object 552 or the space occupied by the physical object 551.

According to an embodiment of the disclosure, the electronic device 501 may arrange a virtual object (not shown) (e.g., an avatar object) representing the user 590 in the virtual space 500. When the avatar object is provided in a first-person view, the electronic device 501 may provide a visualized graphic representation corresponding to a portion of the avatar object (e.g., a hand, a torso, or a leg) to the user 590 via the display described above (e.g., an OST display or a VST display). However, embodiments are not limited thereto, and when the avatar object is provided in a third-person view, the electronic device 501 may provide a visualized graphic representation corresponding to an entire shape (e.g., a back view) of the avatar object to the user 590 via the display described above. The electronic device 501 may provide the user 590 with an experience integrated with the avatar object.

In addition, the electronic device 501 may provide, to the user 590, the experience integrated with the avatar object using an avatar object of another user who enters the same virtual space 500. The electronic device 501 may receive feedback information that is the same as or similar to feedback information (e.g., information based on at least one of visual sensation, auditory sensation, or tactile sensation) provided to another electronic device 501 entering the same virtual space 500. For example, when an object is arranged in any virtual space 500 and a plurality of users access the virtual space 500, respective electronic devices 501 of the plurality of users 590 may receive feedback information (e.g., a graphic representation, a sound signal, or haptic feedback) of the same object arranged in the virtual space 500 and provide the feedback information to each user 590.

The electronic device 501 may detect an input to an avatar object of another electronic device 501 and may receive feedback information from the avatar object of the other electronic device 501. An exchange of inputs and feedback for each virtual space 500 may be performed by a server (e.g., the server 108 of FIG. 1). For example, the server (e.g., a server providing a metaverse space) may transfer, to the users 590, inputs and feedback between the avatar object of the user 590 and an avatar object of another user 590. However, embodiments are not limited thereto, and the electronic device 501 may establish direct communication with another electronic device 501 to provide an input based on an avatar object or receive feedback, not via the server.

For example, based on detecting a user input that selects a manipulation area, the electronic device 501 may determine that the physical object 551 corresponding to the selected manipulation area is selected by the user 590. An input of the user 590 may include at least one of a gesture input made by using a body part (e.g., a hand or eye), an input made by using a separate VR accessory device, or a voice input of the user.

The gesture input may be an input corresponding to a gesture identified by tracking a body part 510 of the user 590 and may include, for example, an input indicating or selecting an object. The gesture input may include at least one of a gesture by which a body part (e.g., a hand) moves toward an object for a predetermined period of time or more, a gesture by which a body part (e.g., a finger, an eye, or a head) points at an object, or a gesture by which a body part and an object contact each other spatially. A gesture of pointing at an object with an eye may be identified based on ET. A gesture of pointing at an object with a head may be identified based on head tracking.

Tracking the body part 510 of the user 590 may be mainly performed based on a camera of the electronic device 501 but is not limited thereto. The electronic device 501 may track the body part 510 based on a cooperation of sensing data of a vision sensor (e.g., image data of a camera and depth data of a depth sensor) and information collected by accessory devices to be described below (e.g., controller tracking or finger tracking in a controller). Finger tracking may be performed by sensing a distance or contact between an individual finger and the controller based on a sensor (e.g., an infrared sensor) embedded in the controller

VR accessory devices may include, for example, a ride-on device, a wearable device, a controller device 520, or other sensor-based devices. The ride-on device, which is a device operated by the user 590 riding thereon, may include, for example, at least one of a treadmill-type device or a chair-type device. The wearable device, which is a manipulation device worn on at least a part of the body of the user 590, may include, for example, at least one of a full body suit-type or a half body suit-type controller, a vest-type controller, a shoe-type controller, a bag-type controller, a glove-type controller (e.g., a haptic glove), or a face mask-type controller. The controller device 520 may include, for example, an input device (e.g., a stick-type controller or a firearm) manipulated by a hand, foot, toe, or other body parts 510.

The electronic device 501 may establish direct communication with an accessory device and track at least one of a position or motion of the accessory device, but embodiments are not limited thereto. The electronic device 501 may communicate with the accessory device via a base station for VR.

For example, the electronic device 501 may determine that the virtual object 552 is selected, based on detecting an act of gazing at the virtual object 552 for a predetermined period of time or more through eye gaze tracking technology described above. In another example, the electronic device 501 may recognize a gesture of pointing at the virtual object 552 through hand tracking technology. The electronic device 501 may determine that the virtual object 552 is selected, based on that a direction in which a tracked hand points indicates the virtual object 552 for a predetermined period of time or more or that a hand of the user 590 contacts or enters an area occupied by the virtual object 552 in the virtual space 500.

The voice input of the user, which is an input corresponding to a user's voice obtained by the electronic device 501, may be detected by, for example, an input module (e.g., a microphone) of the electronic device 501 or may include voice data received from an external electronic device of the electronic device 501. By analyzing the voice input of the user, the electronic device 501 may determine that the physical object 551 or the virtual object 552 is selected. For example, based on detecting a keyword indicating at least one of the physical object 551 or the virtual object 552 from the voice input of the user, the electronic device 501 may determine that at least one of the physical object 551 or the virtual object 552 corresponding to the detected keyword is selected.

The electronic device 501 may provide feedback to be described below as a response to the input of the user 590 described above.

The feedback may include visual feedback, auditory feedback, tactile feedback, olfactory feedback, or gustatory feedback. The feedback may be rendered by the server 108, the electronic device 101, or the external electronic device 102 as described above with reference to FIG. 1.

The visual feedback may include an operation of outputting an image through the display (e.g., a transparent display or an opaque display) of the electronic device 501.

The auditory feedback may include an operation of outputting a sound through a speaker of the electronic device 501.

The tactile feedback may include force feedback that simulates a weight, a shape, a texture, a dimension, and dynamics. For example, the haptic glove may include a haptic element (e.g., an electric muscle) that simulates a sense of touch by tensing and relaxing the body of the user 590. The haptic element in the haptic glove may act as a tendon. The haptic glove may provide haptic feedback to the entire hand of the user 590. The electronic device 501 may provide feedback that represents a shape, a size, and stiffness of an object through the haptic glove. For example, the haptic glove may generate force that simulates a shape, a size, and stiffness of an object. The exoskeleton of the haptic glove (or a suit-type device) may include a sensor and a finger motion measurement device, may transfer cable-pulling force (e.g., an electromagnetic, direct current (DC) motor-based, or pneumatic force) to fingers of the user 590, and may thereby transmit tactile information to the body. Hardware that provides such tactile feedback may include a sensor, an actuator, a power source, and a wireless transmission circuit. The haptic glove may operate by inflating and deflating an inflatable air bladder on a surface of the glove.

Based on an object in the virtual space 500 being selected, the electronic device 501 may provide feedback to the user 590. For example, the electronic device 501 may output a graphic representation (e.g., a representation of highlighting the selected object) indicating the selected object through the display. For example, the electronic device 501 may output a sound (e.g., a voice) notifying the selected object through a speaker. In another example, the electronic device 501 may transmit an electrical signal to a haptic supporting accessory device (e.g., the haptic glove) and may thereby provide a haptic motion that simulates a tactile sensation of a corresponding object to the user 590.

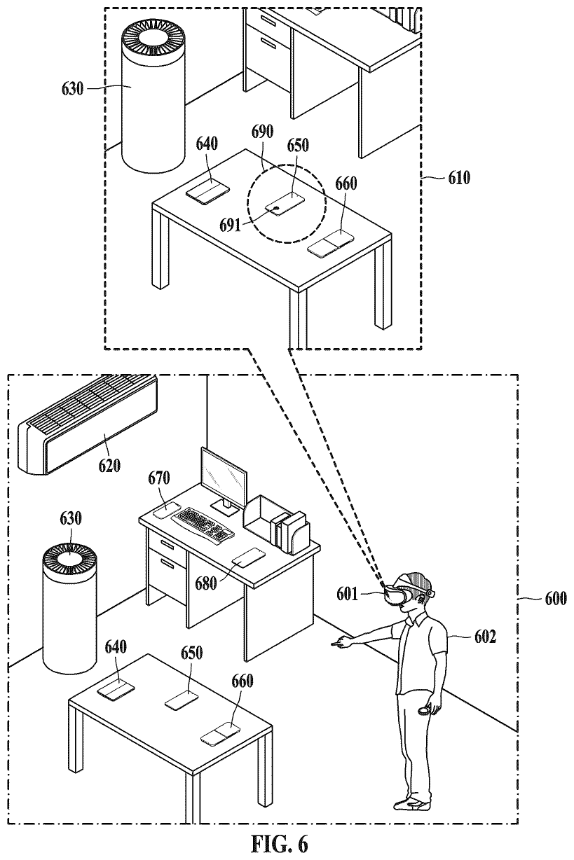

FIG. 6 is a diagram illustrating establishing communication with an external device according to an embodiment of the disclosure.

Referring to FIG. 6, an electronic device 601 (e.g., the electronic device 101 of FIG. 1, the electronic device 201 of FIG. 2, the electronic device 301 of FIG. 3, the electronic device 401 of FIGS. 4A and 4B, and the electronic device 501 of FIG. 5) may be worn by a user 602.

The electronic device 601 may be located in a physical space (hereinafter, also referred to as a ‘surrounding space 600’) together with a plurality of external devices. Referring to FIG. 6, the electronic device 601 may be located in the surrounding space 600 together with an air conditioner 620, an air purifier 630, and a plurality of mobile phones (e.g., a first mobile phone 640, a second mobile phone 650, a third mobile phone 660, a fourth mobile phone 670, and a fifth mobile phone 680). The electronic device 601 may establish communication with the external devices located in the surrounding space 600.

The electronic device 601 may display a display area 610 in the images of the surrounding space 600. The display area 610 may be an area displayed through a display of the electronic device 601. According to an embodiment of the disclosure, the display area 610 may include an area determined to be an FOV of the user 602. The electronic device 601 may determine, to be the display area 610, an area determined to be the FOV of the user 602 in the images obtained through a camera for image capturing (e.g., the third camera 245 of FIG. 2 and the second function cameras 411 and 412 of FIGS. 4A and 4B) and may display the determined display area 610 through the display.

The electronic device 601 may detect an object in the display area 610. According to an embodiment of the disclosure, the electronic device 601 may detect the external device in the display area 610 by analyzing an image obtained through a vision sensor (e.g., a vision sensor including a camera for image capturing). In FIG. 6, the electronic device 601 may detect the air purifier 630, the first mobile phone 640, the second mobile phone 650, and the third mobile phone 660 in the display area 610. The electronic device may determine the category of the air purifier 630 detected in the display area 610 to be an air purifier and may determine the category of the first mobile phone 640, the second mobile phone 650, and the third mobile phone 660 to be a mobile phone.

The electronic device 601 may attempt to establish communication with the external device when the user 602 looks at the external device for a threshold time. For example, the electronic device 601 may detect that a gaze of the user 602 is maintained on the external device (or an area including the external device) for a threshold time by tracking the gaze of the user 602.

The electronic device 601 may detect that the user 602 looks at the external device for a threshold time based on detecting the external device in a viewing region 690 for a threshold time. The viewing region 690 may be a partial area viewed by the user 602 in the area (or the display area 610) determined to be the FOV of the user 602. According to an embodiment of the disclosure, the viewing region 690 may be determined based on a gaze point 691 corresponding to the gaze of the user 602. For example, the viewing region 690 may be determined to be a circular area having a predetermined radius based on the gaze point 691 corresponding to the gaze of the user 602. In another example, the viewing region 611 may be an internal area having an oval shape, a quadrangular shape, or a closed curve. However, the viewing region 690 is not limited to being determined based on the gaze of the user 602. According to an embodiment of the disclosure, the electronic device 601 may determine a predetermined partial area based on the display area 610 to be the viewing region 690 of the user 602.

Referring to FIG. 6, the electronic device 601 may detect that the gaze of the user 602 is maintained on the second mobile phone 650.

To establish communication with the external device, the electronic device 601 may require a device identifier (e.g., a media access control (MAC) address or a Bluetooth device address) of the external device for establishing communication. The device identifier of the external device may be included in a signal for establishing communication and received from the external device. The signal for establishing communication may include, for example, an advertising signal and/or a connection signal when establishing communication using Bluetooth low energy (BLE).

The electronic device 601 may receive signals for establishing communication from the electronic device 601 and a plurality of devices. The electronic device 601 may receive signals for establishing communication from devices capable of establishing communication with the electronic device 601. The plurality of devices may include an external device and other devices different from the external device. The electronic device 601 may determine at least one candidate device based on a category of the external device from among the plurality of devices, determine an external device viewed by the user 602 from among the at least one determined candidate device, and establish communication with the external device using the device identifier of the external device included in signals for establishing communication, which are received from the determined external device.

The electronic device 601 may search for devices capable of establishing communication with the electronic device 601 using a communication module (e.g., the communication module 190 of FIG. 1). Referring to FIG. 6, the electronic device 601 may detect the air conditioner 620, the air purifier 630, and the plurality of mobile phones as devices capable of establishing communication with the electronic device 601. The electronic device 601 may also detect a device that is not displayed in the display area 610 when communication with the electronic device 601 may be established. For example, the air conditioner 620, the fourth mobile phone 670, and the fifth mobile phone 680 may not be detected in the display area 610 but may be detected as devices capable of establishing communication with the electronic device 601 because the air conditioner 620, the fourth mobile phone 670, and the fifth mobile phone 680 may establish communication with the electronic device 601.

The electronic device 601 may determine a candidate device from among devices capable of establishing communication with the electronic device 601. The electronic device 601 may receive signals for establishing communication, which are received from devices capable of establishing communication. The electronic device 601 may determine the candidate device by comparing category information included in signals for establishing communication with the category of the external device. Referring to FIG. 6, based on the category (e.g., a mobile phone) of the second mobile phone 650, which is an external device viewed by the user 602, candidate devices (e.g., the first mobile phone 640, the second mobile phone 650, the third mobile phone 660, the fourth mobile phone 670, and the fifth mobile phone 680) may be determined from among the devices (e.g., the air conditioner 620, the air purifier 630, the first mobile phone 640, the second mobile phone 650, the third mobile phone 660, the fourth mobile phone 670, and the fifth mobile phone 680) capable of establishing communication with the electronic device 601.

The electronic device 601 may determine the external device from among at least one candidate device and establish communication with the external device using the device identifier received from the external device. As described below, the electronic device 601 may determine a reference distance between the external device and the electronic device 601, determine a candidate distance between each candidate device and the electronic device 601, compare the reference distance with the candidate distance, and determine the external device from among at least one candidate device.

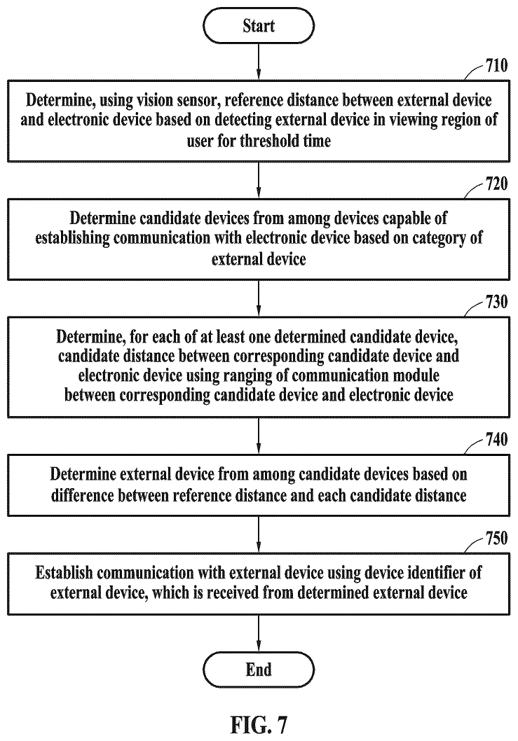

FIG. 7 is a flowchart illustrating determining an external device from among at least one candidate device according to an embodiment of the disclosure.

Referring to FIG. 7, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, and the electronic device 601 of FIG. 6), according to an embodiment of the disclosure, may establish communication with an external device based on a user looking at the external device for a threshold time. As described above, a device identifier of the external device may be required to establish communication with the external device. The electronic device may determine a reference distance between the electronic device and the external device, determine a candidate distance between a candidate device and the electronic device, and establish communication with the external device determined through a comparison between the reference distance and the candidate distance.

In operation 710, the electronic device may determine, using a vision sensor, the reference distance between the external device and the electronic device based on detecting the external device in a viewing region of the user for a threshold time.

The electronic device may detect the external device in the viewing region for a threshold time. According to an embodiment of the disclosure, the electronic device may detect an object (e.g., an external device, a candidate device, a device capable of establishing communication with the electronic device) displayed in a display area. The electronic device may compare the viewing region with the area where the detected object is displayed. The electronic device may determine whether the detected object is detected in the viewing region based on the comparison result.

For example, the electronic device may determine that the external device is detected in the viewing region of the user when the viewing region includes the entire area where the detected object is displayed. The electronic device may determine that the external device is not detected in the viewing region of the user when at least a portion of the area where the object is displayed is not included in the viewing region.

In another example, the electronic device may determine that the external device is detected in the viewing region of the user when the viewing region includes at least a portion of the area where the detected object is displayed. The electronic device may determine that the external device is not detected in the viewing region of the user when the entire area where the object is displayed is not included in the viewing region.

The electronic device may obtain a communication establishment request with the external device based on detecting the external device in the viewing region for a threshold time. The electronic device may determine the reference distance between the external device and the electronic device using the vision sensor. The vision sensor may include a depth sensor (e.g., the depth sensor 417 of FIG. 4A).

In operation 720, the electronic device may determine at least one candidate device from among devices capable of establishing communication with the electronic device based on a category of the external device. The electronic device may determine the category of the external device based on information collected from the vision sensor. For example, the electronic device may obtain an image of the external device from a camera for image capturing (e.g., the third camera 245 of FIG. 2 and the second function cameras 411 and 412 of FIGS. 4A and 4B) included in the vision sensor. The electronic device may determine the category of the external device by analyzing the image of the external device.

The category of the external device may include, for example, at least one of a mobile phone, a desktop, a laptop, a monitor, a television (TV), a tablet, an air conditioner, a dehumidifier, an air purifier, a steam closet, a washing machine, a clothes dryer, a refrigerator, a microwave oven, an oven, an air fryer, a light, a speaker, wireless earphones, and a headset.

However, these categories of the external device are merely examples, and the categories of the external device may change depending on the design. For example, the category of the external device may be defined as a set of categories of a plurality of electronic devices. A set including categories of electronic devices with the same or similar appearance may be defined as one category of the external device. For example, a first set of categories of electronic devices, including a monitor and a TV, may be defined as a first category of the external device, and a second set of categories of electronic devices, including a washing machine and a clothes dryer, may be defined as a second category of the external device. By defining the categories of the electronic devices with the same or similar appearance as one category of the external device, the accuracy of determining the category of the external device by the electronic device may increase.

According to an embodiment of the disclosure, the electronic device may determine the category of the external device based on the external device being detected in the display area. The electronic device may continuously detect an object in the display area. The electronic device may determine the category of the external device when the external device (or at least a portion of the external device) is detected in the display area. Since the electronic device determines (or starts determining) the category of the external device at the time the external device is detected in the display area, the category of the external device may already be determined at the time the external device is detected in the viewing region that is a partial region of the display area.

The electronic device may determine at least one candidate device based on signals for establishing communication, which are received from devices capable of establishing communication with the electronic device.

According to an embodiment of the disclosure, the electronic device may receive category information of a corresponding device from each of the devices capable of establishing communication with the electronic device. The electronic device may determine at least one candidate device based on the received category information. For example, the electronic device may receive a signal for establishing communication, which includes the category information of a corresponding device, from devices capable of establishing communication with the electronic device. The electronic device may select a candidate device by comparing the category of the external device with the category information received from devices capable of establishing communication. For example, the electronic device may select a corresponding device as the candidate device when the category of the external device is the same as the category information received from devices capable of establishing communication. The electronic device may not select a corresponding device as the candidate device when the category of the external device is different from the category information received from devices capable of establishing communication.

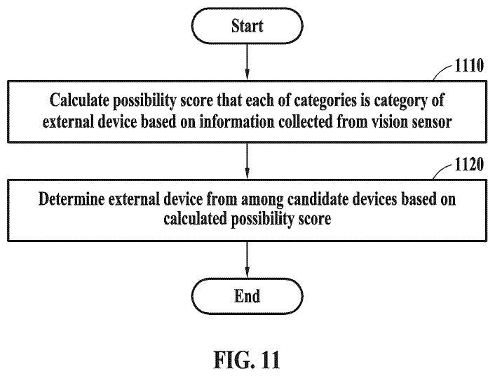

However, the disclosure is not limited to selecting the candidate device based on the category of the external device determined to be one of the plurality of categories. According to an embodiment of the disclosure, the electronic device may determine at least one candidate device based on a possibility score that each of the plurality of categories is the category of the external device. The determination of at least one candidate device based on the possibility score is described below with reference to FIG. 11.

In operation 730, the electronic device may determine, for each of the at least one determined candidate device, a candidate distance between a corresponding candidate device and the electronic device. The electronic device may determine the candidate distance using ranging of a communication module between the candidate device and the electronic device. Ranging of the communication module may refer to a technique for determining a distance between the electronic device and the candidate device based on information obtained by transmitting and receiving signals between the electronic device and the candidate device.

According to an embodiment of the disclosure, among devices capable of establishing communication with the electronic device, the electronic device may restrict determining the candidate distance using ranging for a device that is not determined to be the candidate device. According to an embodiment of the disclosure, since the electronic device does not determine distances to the electronic device using ranging for all devices capable of establishing communication with the electronic device but determines, using ranging, the candidate distance to the electronic device only for at least one candidate device determined based on the category of the external device, an embodiment may reduce an operating time, computational amount, and/or power consumption, compared to a comparative embodiment in which a distance is determined through ranging with all devices capable of establishing communication.

For reference, since the reference distance between the external device and the electronic device is determined based on the vision sensor (e.g., a depth sensor) and the candidate distance between the candidate device and the electronic device is determined based on the communication module, the reference distance and the candidate distance may differ due to errors in the vision sensor and/or the communication module, even when the candidate device is an external device.

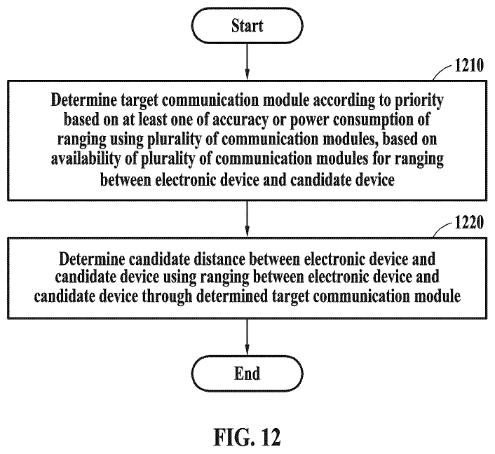

According to an embodiment of the disclosure, the electronic device may determine the candidate distance using a target communication module among a plurality of communication modules, based on the plurality of communication modules being available for ranging between the electronic device and the candidate device. The determination of the candidate distance using the target communication module is described below with reference to FIG. 12.

In operation 740, the electronic device may determine the external device from among at least one candidate device based on a difference between the reference distance and each candidate distance. For example, the electronic device may determine, from among at least one candidate distance, a candidate distance of which a square of the difference from the reference distance is the smallest. The electronic device may determine a candidate device corresponding to the determined candidate distance to be the external device.

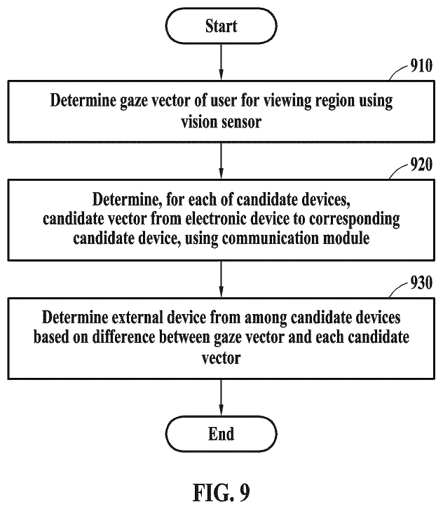

According to an embodiment of the disclosure, the electronic device may determine the external device from among candidate objects, further based on a difference between a gaze vector corresponding to the gaze of the user and a candidate vector corresponding to a candidate object, along with the candidate distance and the reference distance. The determination of the external device based on the gaze vector and the candidate vector is described below with reference to FIG. 9.

In operation 750, the electronic device may establish communication with the external device using the device identifier of the external device, which is received from the determined external device.

For example, the electronic device may obtain a signal (hereinafter, referred to as a “target signal”) for establishing communication, which is received from the external device, among signals for establishing communication, which are received from devices capable of establishing communication with the electronic device. The electronic device may establish communication with the external device using the device identifier of the external device included in the target signal.

For example, the electronic device may transmit, to the determined external device, a signal requesting transmission of the device identifier. The external device may transmit the device identifier of the external device to the electronic device. The electronic device may establish communication with the external device using the device identifier of the external device received from the external device.

According to an embodiment of the disclosure, the electronic device may trigger a service assigned to the external device based on establishing communication with the external device. For example, the electronic device may display a virtual object (e.g., a virtual controller) for controlling the external device in an area corresponding to the external device. The virtual object for controlling the external device may include an object for obtaining a user's command for the external device. The electronic device may transmit the user's command to the external device based on obtaining the user's command for the virtual object. The external device may perform an operation designated by the user's command based on receiving the user's command from the electronic device.

Although not explicitly shown in FIG. 7, according to an embodiment of the disclosure, the electronic device may determine whether the external device supports wireless communication based on the category of the external device. The electronic device may perform operations 710, 720, 730, 740, and 750 based on determining that the external device supports wireless communication. The electronic device may limit the performance of operations 710, 720, 730, 740, and 750 based on determining that the external device does not support wireless communication. The electronic device may provide feedback (e.g., visual feedback or auditory feedback) to the user regarding the inability to establish wireless communication because the external device does not support wireless communication, based on determining that the external device does not support wireless communication.

According to an embodiment of the disclosure, the electronic device may restrict establishing communication with another device based on receiving a communication establishment request from the determined external device and another device. For example, when the electronic device receives a communication establishment request from the other device, the other device is not detected in the viewing region of the user, so the user may determine that there is no intention to establish communication with the other device. When detecting the external device in the viewing region of the user for a threshold time, the electronic device may obtain a user's command for establishing communication between the external device and the electronic device and may further obtain a user's command for restricting the establishment of communication between the external device and the other device.

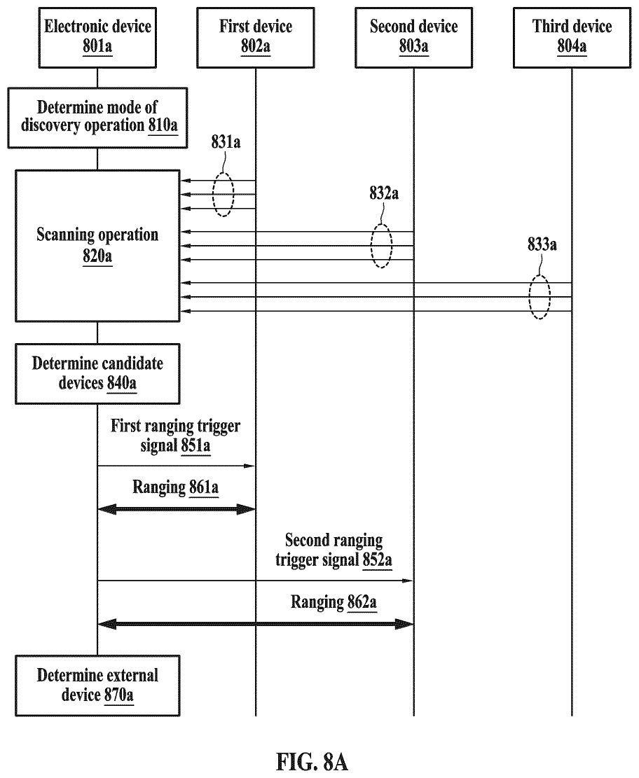

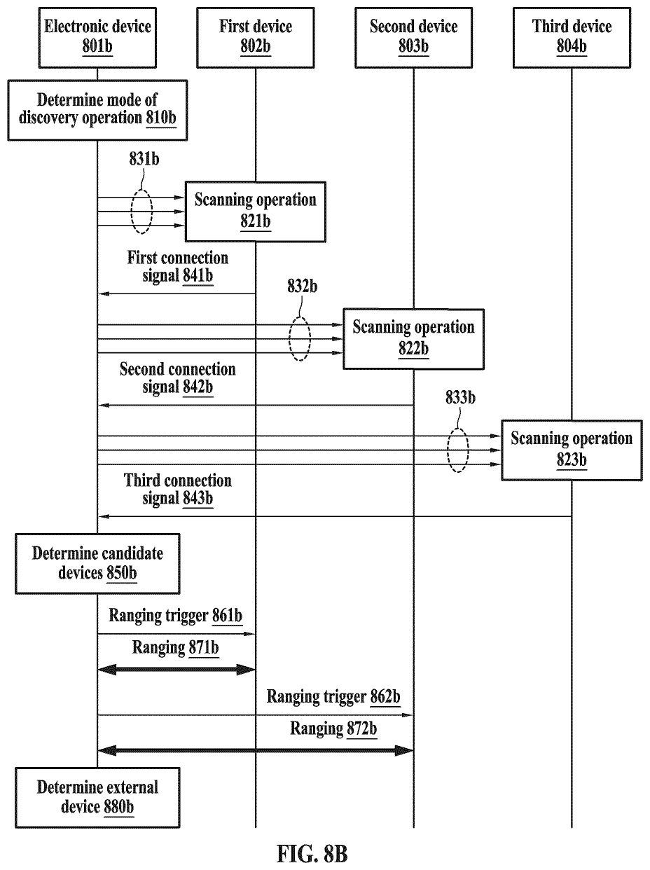

FIG. 8A is a flowchart illustrating an electronic device operates as a central device in a discovery operation according to an embodiment of the disclosure. FIG. 8B is a flowchart illustrating an electronic device operates as a peripheral device in the discovery operation according to an embodiment of the disclosure.

An electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, and the electronic device 601 of FIG. 6), according to an embodiment of the disclosure, may determine at least one candidate device from among devices capable of establishing communication with the electronic device. The electronic device may perform a discovery operation to search for devices capable of establishing communication. The discovery operation may include transmitting and receiving signals between the electronic device and the devices capable of establishing communication with the electronic device.

For example, in the BLE communication method, to establish communication between a first device and a second device, one of the first device or the second device may operate as a central device, and the other device may operate as a peripheral device. The peripheral device may emit an advertisement (also referred to as an ‘advertisement signal’) indicating that the peripheral device is capable of establishing communication using the BLE communication method. The advertisement may include a device identifier of the peripheral device. The central device may perform a scanning operation to detect an advertisement emitted by the peripheral device. The central device may obtain an advertisement emitted by the peripheral device and transmit a connection signal for establishing communication with the peripheral device. The connection signal may include a device identifier of the central device. The central device and the peripheral device may obtain each other's device identifiers through emission of an advertisement, detection of an advertisement, and transmission and reception of a connection signal and may establish communication between the central device and the peripheral device.

The electronic device, according to an embodiment of the disclosure, may determine whether to operate as a central device or operate as a peripheral device in the discovery operation of the electronic device based on a category of an external device. The electronic device, according to an embodiment of the disclosure, may operate as a central device and operate as a peripheral device when performing the discovery operation. The electronic device may determine the role in the discovery operation based on a possible role (e.g., a central device, a peripheral device, or a central device and a peripheral device) of the external device for the discovery operation. The role of the external device in the discovery operation may be determined based on the category of the external device.

For example, a device belonging to a first category of the external device may operate as a central device in the discovery operation. A device belonging to a second category of the external device may operate as a peripheral device in the discovery operation. The electronic device may determine the mode of the discovery operation to be a peripheral mode when the category of the external device is the first category. The electronic device may determine the mode of the discovery operation to be a central mode when the category of the external device is the second category.

Referring to FIG. 8A, it illustrates a case in which an electronic device 801a operates as a central device in a discovery operation. For example, the external device may be a first device 802a, a category of a second device 803a may be the same as a category of the first device 802a, and a category of a third device 804a may be different from the category of the third device 804a. The category of the first device 802a may operate as a peripheral device in the discovery operation.

In operation 810a, the electronic device 801a may determine the role of the electronic device 801a in the discovery operation. The electronic device 801a may determine whether the electronic device 801a operates as a central device or operates as a peripheral device in the discovery operation based on the category of the external device.

In operation 820a, the electronic device 801a may perform a scanning operation. The electronic device 801a may detect a first advertisement received from the first device 802a, a second advertisement received from the second device 803a, and a third advertisement received from the third device 804a, while performing a scanning operation.

In operation 840a, the electronic device 801a may determine at least one candidate device based on category information included in the advertisement. For example, the electronic device 801a may determine the first device 802a and the second device 803a to be candidate devices.

In operation 851a, the electronic device 801a may transmit a first ranging trigger signal to the first device 802a. In operation 861a, the electronic device 801a may determine a first candidate distance between the electronic device 801a and the first device 802a using ranging between the electronic device 801a and the first device 802a.

In operation 852a, the electronic device 801a may transmit a second ranging trigger signal to the second device 803a. In operation 862a, the electronic device 801a may determine a second candidate distance between the electronic device 801a and the second device 803a using ranging between the electronic device 801a and the second device 803a.

In operation 870a, the electronic device 801a may determine an external device. The electronic device 801a may determine, using a vision sensor, the external device by comparing the first candidate distance and the second candidate distance with a reference distance between the electronic device 801a and the determined external device. In FIG. 8A, the electronic device 801a may determine the first device 802a to be the external device from among the first device 802a and the second device 803a.

Referring to FIG. 8B, it illustrates a case in which an electronic device 801b operates as a peripheral device in a discovery operation. Referring to FIG. 8A, an external device may be a first device 802b, a category of a second device 803b may be the same as a category of the first device 802b, and a category of a third device 804b may be different from the category of the third device 804b. The category of the first device 802b may operate as a peripheral device in the discovery operation.

In operation 810b, the electronic device 801b may determine the role of the electronic device 801b in the discovery operation. The electronic device 801b may determine whether the electronic device 801b operates as a central device or operates as a peripheral device in the discovery operation based on the category of the external device.

In operation 821b, the first device 802b may perform a scanning operation. The first device 802b may detect a first advertisement 831b received from the electronic device 801b while performing a scanning operation. In operation 841b, the first device 802b may transmit a first connection signal to the electronic device 801b.

In operation 822b, the second device 803b may perform a scanning operation. The second device 803b may detect a second advertisement 832b received from the electronic device 801b while performing a scanning operation. In operation 842b, the second device 803b may transmit a second connection signal to the electronic device 801b.

In operation 823b, the third device 804b may perform a scanning operation. The third device 804b may detect a third advertisement 833b received from the electronic device 801b while performing a scanning operation. In operation 843b, the third device 804b may transmit a third connection signal to the electronic device 801b.

In operation 850b, the electronic device 801b may determine at least one candidate device based on category information included in the first connection signal, the second connection signal, and the third connection signal. For example, the electronic device 801b may determine the first device 802b and the second device 803b to be candidate devices.

In operation 861b, the electronic device 801b may transmit a first ranging trigger signal to the first device 802b. In operation 871b, the electronic device 801b may determine a first candidate distance between the electronic device 801b and the first device 802b using ranging between the electronic device 801b and the first device 802b.

In operation 862b, the electronic device 801b may transmit a second ranging trigger signal to the second device 803b. In operation 872b, the electronic device 801b may determine a second candidate distance between the electronic device 801b and the second device 803b using ranging between the electronic device 801b and the second device 803b.

In operation 880b, the electronic device 801b may determine an external device. The electronic device 801b may determine, using a vision sensor, the external device by comparing the first candidate distance and the second candidate distance with a reference distance between the electronic device 801b and the determined external device. In FIG. 8B, the electronic device 801b may determine the first device 802b to be the external device from among the first device 802b and the second device 803b.

FIG. 9 is a diagram illustrating an electronic device uses a gaze vector and a candidate vector for establishing communication with an external device according to an embodiment of the disclosure.

Referring to FIG. 9, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, the electronic device 601 of FIG. 6, the electronic device 801a of FIG. 8A, and the electronic device 801b of FIG. 8B), according to an embodiment of the disclosure, may determine an external device from among at least one candidate device based on a gaze vector and a candidate vector.

In operation 910, the electronic device may determine a gaze vector of a user for a viewing region. The gaze vector of the user may be a vector having a direction from a reference point (e.g., a center point of the electronic device) to a point (e.g., a gaze point) of the viewing region and having a predetermined size. The gaze vector of the user may be obtained by tracking the gaze of the user. Since the electronic device detects an external device that the user looks at for a threshold time by detecting the external device in the viewing region of the user for a threshold time, the gaze vector of the user may have a direction from the electronic device to the external device.

According to an embodiment of the disclosure, depending on the arrangement of an antenna of a communication module, the gaze vector of the user may be determined based on at least one of an elevation angle or an azimuth angle. The elevation angle may be an angle with a reference plane (e.g., a transverse plane of the user's head). The azimuth angle may be an angle in the left and right directions with respect to a reference direction (e.g., a direction perpendicular to the coronal plane of the user's head).

In operation 920, the electronic device may determine, for each of at least one candidate device, a candidate vector from the electronic device to a corresponding candidate device, using the communication module.

The candidate vector may be a vector having a direction from the electronic device to the candidate device and having a predetermined size. The candidate vectors from the electronic device to at least one candidate device may have the same size. For example, the candidate vector may have a direction from the communication module of the electronic device to a communication module of the candidate device. In another example, the electronic device may determine a temporary candidate vector having a direction from the communication module of the electronic device to the communication module of the candidate device and may determine a candidate vector from a reference point (e.g., a center point of the electronic device) to a reference point (e.g., the center of the candidate device) of the candidate device by performing conversion on the temporary candidate vector.

According to an embodiment of the disclosure, the electronic device may perform operations 910 and 920 described above after the determination operation of the candidate device (e.g., operation 720 of FIG. 7).

In operation 930, the electronic device may determine the external device from among at least one candidate device based on a difference between the gaze vector and each candidate vector.

For example, the electronic device may calculate the difference between the gaze vector and each candidate vector. The electronic device may determine, to be the external device, a candidate device corresponding to a candidate vector having the smallest difference among the differences. For example, the difference between the gaze vector and the candidate vector may be defined as a cosine value of the angle between the gaze vector and the candidate vector. However, embodiments are not limited to thereto, and the difference may also be defined as a size of a vector obtained by subtracting the candidate vector from the gaze vector.

According to an embodiment of the disclosure, the electronic device may determine the external device from among at least one candidate device further based on the difference between the gaze vector and the candidate vector, along with the difference between a reference distance and a candidate distance. The electronic device may determine a combined difference using a distance weight for the difference between the reference distance and the candidate distance and an angle weight for the difference between the gaze vector and the candidate vector. The electronic device may determine the combined difference for each of at least one candidate device and determine, to be the external device, a candidate device having the smallest value among the combined differences.

For example, the electronic device may determine the combined difference according to Equation 1 below.

$$C D = {w}_{1} \times {( {d}_{ToF} - {d}_{ranging} )}^{2} + {w}_{2} \times {( {A}_{ToF} - {A}_{ranging} )}^{2} \qquad Equation 1$$

Here, CD denotes a combined difference corresponding to a candidate device, w₁ denotes a distance weight, w₂ denotes an angle weight, d_{ToF} denotes a reference distance, d_{ranging} denotes a candidate distance, A_{ToF} denotes a gaze vector, and A_{ranging} denotes a candidate vector.

According to an embodiment of the disclosure, the electronic device may perform operation 930 as at least part of the determination operation of the external device (e.g., operation 740 of FIG. 7).

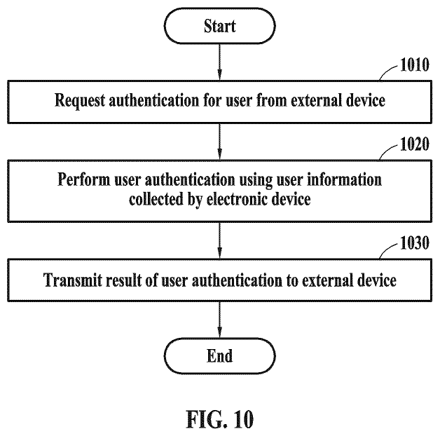

FIG. 10 is a flowchart illustrating an electronic device performs authentication for an external device according to an embodiment of the disclosure.

Referring to FIG. 10, according to an embodiment of the disclosure, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, the electronic device 601 of FIG. 6, the electronic device 801a of FIG. 8A, and the electronic device 801b of FIG. 8B) may need to perform user authentication required by an external device to access a function and/or memory of the external device.

In operation 1010, the electronic device may receive an authentication request for a user from the external device. For example, the electronic device may access the function and/or memory of the external device based on the user wearing the electronic device being authenticated as a registered user in the external device. The electronic device may restrict access to the function and/or memory of the external device based on the user wearing the electronic device being a different user (e.g., failed authentication as a registered user in the external device) from the registered user in the external device. In another example, the electronic device may establish communication with the external device based on the user wearing the electronic device being authenticated as a registered user in the external device. The electronic device may restrict the establishment of communication with the electronic device based on the user wearing the electronic device being a different user (e.g., failed authentication as a registered user in the external device) from the registered user in the external device.

In operation 1020, the electronic device may perform user authentication using user information collected by the electronic device. For example, the user information may include biometric information (e.g., iris information, fingerprint information, or facial information). However, the user information used for user authentication is not limited to the biometric information and may also include a string registered by the user, such as password information and/or unlock patterns.

According to an embodiment of the disclosure, the electronic device may compare the user information with registered user information about a registered user. The electronic device may obtain a user identifier of the registered user based on determining that the user wearing the electronic device is the same person as the registered user based on the user information and the registered user information. The electronic device may determine that user authentication fails when determining the registered user who is the same person as the user wearing the electronic device based on the user information and the registered user information fails.

In operation 1030, the electronic device may transmit the result of user authentication to the external device.

The result of user authentication may include the user identifier of the registered user when it is determined that the user wearing the electronic device is the same person as the registered user. The external device may receive the user identifier of the registered user from the electronic device. The external device may determine whether the user wearing the electronic device has authority over the external device based on the received user identifier.

For example, the external device may store the user identifier of the registered user in the external device. The external device may compare the user identifier received from the electronic device with the user identifier of the registered user in the external device. When the user identifier of the registered user in the external device corresponds to (e.g., is the same as) the user identifier received from the electronic device, the external device may establish communication with the electronic device. When the user identifier of the registered user in the external device does not correspond to the user identifier received from the electronic device, the external device may restrict establishing communication with the electronic device.

The result of user authentication may include a failure of user authentication when determining the registered user who is the same person as the user wearing the electronic device fails. The external device may limit establishing communication with the electronic device when receiving a failure of user authentication as a result of user authentication.

Herein, it is mainly described that the electronic device performs user authentication and transmits the result of user authentication to the external device, but embodiments are not limited thereto. For example, the electronic device may collect user information (e.g., a password or an unlock pattern). The electronic device may transmit the collected user information to the external device. The external device may perform user authentication by comparing the user information received from the electronic device with the registered user information of the registered user in the external device. The external device may determine whether to establish communication with the electronic device based on the result of user authentication.

FIG. 11 is a flowchart illustrating determining an external device using probability scores for a plurality of categories for a category of the external device according to an embodiment of the disclosure.

Referring to FIG. 11, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, the electronic device 601 of FIG. 6, the electronic device 801a of FIG. 8A, and the electronic device 801b of FIG. 8B), according to an embodiment of the disclosure, may calculate a probability score for each category for the category of the external device and may determine the external device from among at least one candidate device further based on the calculated probability score, along with a distance difference (e.g., a difference between a reference distance and a candidate distance) and/or an angle difference (e.g., a difference between a gaze vector and a candidate vector).

In operation 1110, the electronic device may calculate a possibility score that each of the plurality of categories is the category of the external device based on information collected from a vision sensor. The electronic device may calculate the probability score for each of the plurality of categories based on the information collected from the vision sensor (e.g., a camera for image capturing). Each of the plurality of probability scores may have a value greater than or equal to 0 and less than or equal to 1. In an embodiment of the disclosure, the sum of the calculated probability scores may be 1. However, embodiments are not limited thereto, and the sum of the possibility scores may exceed 1.

For example, the electronic device may calculate the possibility score that each of the plurality of categories is the category of the external device based on an image captured for the external device. The plurality of categories may be predetermined to be a set of categories. For example, the plurality of categories may be a washing machine, a clothes dryer, a refrigerator, and a TV. The electronic device may calculate a first possibility score that the washing machine is the category of the external device as 0.52, a second possibility score that the clothes dryer is the category of the external device as 0.46, a third possibility score that the refrigerator is the category of the external device as 0.01, and a possibility score that the TV is the category of the external device as 0.01.

According to an embodiment of the disclosure, the electronic device may select candidate categories based on the plurality of possibility scores calculated for the plurality of categories. The candidate category may be a candidate for the category of the external device.

For example, when there are two or more possibility scores exceeding a threshold score (e.g., 0.4) among the plurality of possibility scores, the electronic device may determine categories for the possibility scores exceeding the threshold score to be candidate categories. The electronic device may determine a device corresponding to the candidate category to be the candidate device from among devices capable of establishing communication with the electronic device. Since at least two of the candidate devices may correspond to different categories, the electronic device may determine the difference between the candidate device and the external device based on a category weight according to the category. The determination of the difference based on the category weight is described below in operation 1020.

For example, when there is one possibility score exceeding a threshold score (e.g., 0.4) among the plurality of possibility scores, the electronic device may determine a category for the possibility score exceeding the threshold score to be the category of the external device. The electronic device may determine, to be the candidate device, a device of the category that is the same as the determined category of the external device. Since at least one category of the candidate device is the same as the category of the external device, the electronic device may determine the difference between the candidate device and the external device independently from the category of the candidate device. For example, the electronic device may exclude the category of the candidate device from determining the difference between the candidate device and the external device.

In operation 1120, the electronic device may determine the external device from among at least one candidate device based on the calculated possibility score.

According to an embodiment of the disclosure, the electronic device may determine the external device further based on the possibility score, along with the distance difference and/or the angle difference. The electronic device may determine the category of the candidate device based on category information included in a signal for establishing communication, which is received from the candidate device.

The electronic device may apply (e.g., multiply) the category weight based on the possibility score for the category of the candidate device to the difference (e.g., a distance difference, an angle difference, or a combined difference based on the distance difference and the angle difference) between the external device and the candidate device. The category weight may have a positive real number value. For example, the electronic device may apply the category weight having a smaller value as the possibility score for the category of the candidate device increases. When the first possibility score for a first category is greater than the second possibility score for a second category, a first category weight for the first category may have a smaller value than a second category weight for the second category. When the first category weight has a larger value than the second category weight, the first category weight may increase the difference of the candidate device of the first category compared to the second category weight. Consequently, as the possibility score for the category decreases, the category weight for a category increases, which may increase the difference between the candidate device of a corresponding category and the external device.

The electronic device may determine, to be the external device, the candidate device having the smallest difference among differences between the external device and at least one candidate device, in which the differences may be calculated based on the possibility scores for the category of at least one candidate device.

When the category of the external device is definitively determined (e.g., estimated) to be one category based on information collected for the external device, the category of the external device may be incorrectly determined to be a category different from the actual category. The electronic device, according to an embodiment of the disclosure, may select the candidate device by calculating the possibility score for each category for the category of the external device and aggregating the possibility score with differences (e.g., a distance difference, an angle difference, a combined difference) between the candidate device and the electronic device, even when the determination of the category based on the appearance of the external device is not clear.

FIG. 12 is a flowchart illustrating an electronic device determines a target communication module when a plurality of communication modules is available for ranging between the electronic device and a candidate device according to an embodiment of the disclosure.

Referring to FIG. 12, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, the electronic device 601 of FIG. 6, the electronic device 801a of FIG. 8A, and the electronic device 801b of FIG. 8B), according to an embodiment of the disclosure, may determine a target communication module from among a plurality of communication modules and determine a candidate distance using ranging through the target communication module, based on the plurality of communication modules being available for ranging to obtain the candidate distance.

In operation 1210, the electronic device may determine the target communication module from among the plurality of communication modules according to a priority based on the availability of the plurality of communication modules for ranging between the electronic device and the candidate device.

According to an embodiment of the disclosure, the communication module of the electronic device may include the plurality of communication modules. The plurality of communication modules may correspond to a plurality of communication methods. For example, the communication module may correspond to a communication method supported by a corresponding communication module. In an embodiment of the disclosure, the communication modules may have a one-to-one correspondence to the communication methods. However, embodiments are not limited thereto, and the plurality of communication modules may correspond to one communication method.

When a specific communication method is supported by the communication module of the electronic device, when the candidate device includes another communication module that supports the same communication method, and when ranging between the communication module of the electronic device and another communication module of the candidate device may be performed using a specific communication method, the communication module of the electronic device (or another communication module of the candidate device) may be determined to be available for ranging between the electronic device and the candidate device. The communication method may include, for example, at least one of an ultra-wideband (UWB) communication method (UWB technology), a Wi-Fi 4 communication method (also referred to as an ‘Institute of Electrical and Electronics Engineers (IEEE) 802.11n communication method’), a Wi-Fi 5 communication method (also referred to as an ‘IEEE 802.11ac communication method’), a Wi-Fi 6 communication method & a Wi-Fi 6E communication method (also referred to as an ‘IEEE 802.11ax communication method’), a Wi-Fi 7 communication method (also referred to as an ‘IEEE 802.11be communication method’), an IEEE 802.11ad communication method, or an IEEE 802.11ay communication method.

The priority may be based on at least one of the accuracy or the power consumption of ranging using the plurality of communication modules. The communication module may be mapped to a higher priority as the communication module has higher accuracy and lower power consumption.

Each of the plurality of communication modules may be mapped to the priority. The electronic device may determine, from among the plurality of communication modules available for ranging, a communication module mapped to the highest priority to be the target communication module.

For example, the electronic device may include a first communication module and a second communication module. The first communication module may support a UWB communication method. The second communication module may support a Wi-Fi 7 communication method. Ranging may be performed in both the UWB communication method and the Wi-Fi 7 communication method.

Based on the fact that a first candidate device includes the communication module supporting the UWB communication method and does not include the communication module supporting the Wi-Fi 7 communication method, ranging between the electronic device and the first candidate device may be performed by the first communication module through the UWB communication method.

Based on the fact that a second candidate device does not include the communication module supporting the UWB communication method but includes the communication module supporting the Wi-Fi communication method, ranging between the electronic device and the second candidate device may be performed by the second communication module through the Wi-Fi communication method.

Based on the fact that a third candidate device includes the communication module supporting the UWB communication method and the communication module supporting the Wi-Fi communication method, ranging between the electronic device and the first candidate device may be performed by at least one of the first communication module and the second communication module. For example, when the UWB communication method has higher accuracy in ranging than the Wi-Fi communication method, the first communication module may be mapped to a higher priority than the second communication module. The electronic device may determine one of the first communication module and the second communication module to be the target communication module.

In operation 1220, the electronic device may determine a candidate distance between the electronic device and the candidate device using ranging between the electronic device and the candidate device via the determined target communication module.

According to an embodiment of the disclosure, the communication methods supported by the communication module included in at least one candidate device may be different from each other, and the electronic device may determine a communication module that is different for each candidate device to be the target communication module. For example, the electronic device may determine the first communication module to be the target communication module for the first candidate device and may determine the second communication module to be the target communication module for the second candidate device. The electronic device may determine the candidate distance between the electronic device and the first candidate device by performing ranging through the first communication module. The electronic device may determine the candidate distance between the electronic device and the second candidate device by performing ranging through the second communication module.

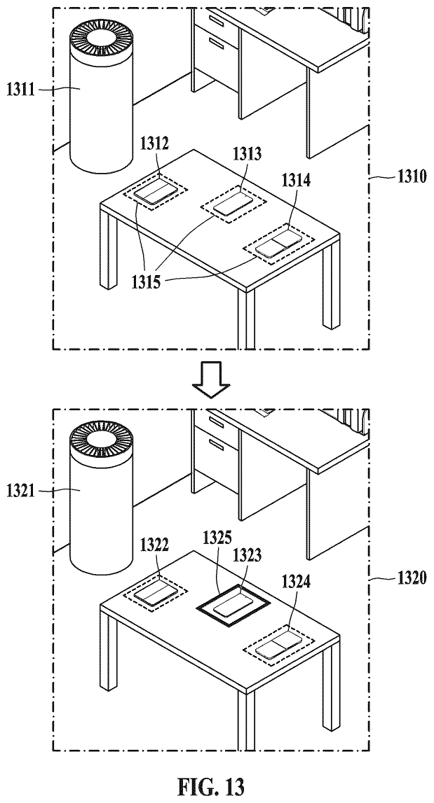

FIG. 13 is a diagram illustrating a feedback interface for at least one candidate device and external devices, provided by an electronic device, according to an embodiment of the disclosure.

Referring to FIG. 13, an electronic device (e.g., the electronic device 101 of FIG. 1, the electronic device 201 of FIG. 2, the electronic device 301 of FIG. 3, the electronic device 401 of FIGS. 4A and 4B, the electronic device 501 of FIG. 5, the electronic device 601 of FIG. 6, the electronic device 801a of FIG. 8A, and the electronic device 801b of FIG. 8B), according to an embodiment of the disclosure, may provide visual feedback for at least one determined candidate device and provide visual feedback for a determined external device from among at least one candidate device.

According to an embodiment of the disclosure, based on detecting a device corresponding to a category of the external device in a display area (e.g., a first display area 1310) displayed by the electronic device, the electronic device may display a first graphic representation 1315 in an area corresponding to the detected device. The device corresponding to the category of the external device may be a device of which a category is the same as the category of the external device. Since the electronic device determines a candidate device based on the category of the external device, among the devices detected in the display area, the device corresponding to the category of the external device may be a device determined to be the candidate device. The electronic device may provide feedback about the candidate device to the user by displaying the first graphic representation 1315 for the device corresponding to the category of the external device in the display area.

However, the disclosure is not limited to the electronic device determining a device to display the first graphic representation 1315 based on the category of the external device. According to an embodiment of the disclosure, the electronic device may display the first graphic representation 1315 based on whether the device detected in the display area is a device determined to be the candidate device. Since the electronic device determines the candidate device based on a signal for establishing communication, which is received from the candidate device, additional operations may be required to verify that a device detected by a vision sensor is one of the at least one determined candidate device, independently from the communication module. For example, the electronic device may determine whether the detected device is a device determined to be the candidate device by determining, using the vision sensor, a distance between the device detected in the display area and the electronic device and by comparing the distance with a candidate distance between the electronic device and each candidate device, in which the candidate distance is determined using ranging of the communication module. The electronic device may display the first graphic representation 1315 in an area corresponding to the detected device based on determining the detected device to be the device that is determined to be the candidate device.

Referring to FIG. 13, the first display area 1310 may include an area corresponding to an air purifier 1311, an area corresponding to a first mobile phone 1312, an area corresponding to a second mobile phone 1313, and an area corresponding to a third mobile phone 1314. In FIG. 13, the external device may be the second mobile phone 1313, the category of the external device may be a mobile phone, and the candidate devices selected based on the category of the external device may be the first mobile phone 1312, the second mobile phone 1313, and the third mobile phone 1314. The electronic device may display the first graphic representation 1315 in each of the area corresponding to the first mobile phone 1312, the area corresponding to the second mobile phone 1313, and the area corresponding to the third mobile phone 1314. The electronic device may restrict displaying the first graphic representation 1315 in the area corresponding to the air purifier 1311 that does not correspond to the category (e.g., a mobile phone) of the external device.

The electronic device may display a second graphic representation 1325 in an area corresponding to the external device among viewing regions of the user, based on determining the external device. The second graphic representation 1325 may be a graphic representation for representing that the external device is determined from among at least one candidate device. In an embodiment of the disclosure, the second graphic representation 1325 may have characteristics that attract the user's attention more than the first graphic representation 1315. For example, the contrast of the surrounding area of the second graphic representation 1325 may be greater than the contrast of the first graphic representation 1315. For example, when the first graphic representation 1315 and the second graphic representation 1325 include lines, the lines included in the first graphic representation 1315 may be thinner than the lines included in the second graphic representation 1325. For example, the transparency of the first graphic representation 1315 may be higher than the transparency of the second graphic representation 1325.

Referring to FIG. 13, the electronic device may display a second display area 1320 based on determining the external device. The electronic device may display the second graphic representation 1325 in an area corresponding to a second mobile phone 1323. The electronic device may restrict displaying the second graphic representation 1325 in an area corresponding to a device (e.g., an air purifier 1321, a first mobile phone 1322, and a third mobile phone 1324) different from the external device.

In the second display area 1320, although the electronic device is illustrated as displaying a first graphic representation in each of the area corresponding to the first mobile phone 1322 and the area corresponding to the third mobile phone 1324, embodiments are not limited thereto. For example, the electronic device may stop displaying the first graphic representation based on determining the external device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a complier or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For the purpose of simplicity, the description of a processing device is singular, however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments of the disclosure, or they may be of the kind well-known and available to those having skill in the computer software arts. Examples of non-transitory computer-readable media include magnetic media, such as hard disks, floppy disks, and magnetic tape; optical media, such as CD-ROM discs and digital versatile discs (DVDs); magneto-optical media, such as optical discs; and hardware devices that are specially configured to store and perform program instructions, such as read-only memory (ROM), random-access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments of the disclosure, or vice versa.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a vision sensor;
a communication module;
memory, comprising one or more storage media, storing instructions; and
at least one processor communicatively coupled to the vision sensor, the communication module, and the memory,
wherein the instructions, when executed by the at least one processor individually or collectively, cause the electronic device to:
determine, using the vision sensor, a reference distance between an external device and the electronic device, based on detecting the external device in a viewing region of a user for a threshold time,
determine, based on a category of the external device, at least one candidate device from among devices capable of establishing communication with the electronic device,
determine, for each of the at least one determined candidate device, a candidate distance between a corresponding candidate device and the electronic device using ranging of the communication module between a corresponding candidate device and the electronic device,
determine, based on a difference between the reference distance and each candidate distance, the external device from among the at least one candidate device, and
establish communication with the external device using a device identifier of the external device, which is received from the determined external device.

2. The electronic device of claim 1, wherein the instructions, when executed by the at least one processor individually or collectively, further cause the electronic device to determine the category of the external device based on information collected from the vision sensor.

3. The electronic device of claim 2, wherein the instructions, when executed by the at least one processor individually or collectively, further cause the electronic device to:
determine, using the vision sensor, a gaze vector of the user for the viewing region,
determine, for each of the at least one candidate device, a candidate vector from the electronic device to a corresponding candidate device, using the communication module, and
determine, based on a difference between the gaze vector and each candidate vector, the external device from among the at least one candidate device.

4. The electronic device of claim 3, wherein the instructions, when executed by the at least one processor individually or collectively, further cause the electronic device to determine, based on the category of the external device, whether the electronic device operates as a central device or operates as a peripheral device in a discovery operation.

5. The electronic device of claim 1, wherein the instructions, when executed by the at least one processor individually or collectively, further cause the electronic device to:
receive category information of a corresponding device from each of the devices capable of establishing communication with the electronic device, and
determine the at least one candidate device based on the received category information.

6. The electronic device of claim 1, wherein the instructions, when executed by the at least one processor individually or collectively, further cause the electronic device to:
receive an authentication request for the user from the external device,
perform user authentication using user information collected by the electronic device, and
transmit a result of the user authentication to the external device.

7. The electronic device of claim 2, wherein the instructions, when executed by the at least one processor individually or collectively, further cause the electronic device to:
calculate, based on the information collected from the vision sensor, a possibility score that each of a plurality of categories is the category of the external device, and
determine the external device from among the at least one candidate device based on the calculated possibility score.

8. The electronic device of claim 1,
wherein the communication module comprises a plurality of communication moules, and
wherein the instructions, when executed by the at least one processor individually or collectively, further cause the electronic device to:
based on a plurality of communication modules being available for ranging between the electronic device and a candidate device, determine a target communication module from among the plurality of communication modules, according to a priority based on at least one of accuracy or power consumption of ranging using the plurality of communication modules, and
determine a candidate distance between the electronic device and the candidate device, using ranging between the electronic device and the candidate device via the determined target communication module.

9. The electronic device of claim 1, wherein when executed by the at least one processor individually or collectively, further cause the electronic device to:
based on detecting a device corresponding to the category of the external device in a display area displayed by the electronic device, display a first graphic representation in an area corresponding to the detected device, and
based on determining the external device, display a second graphic representation in an area corresponding to the external device in the viewing region.

10. The electronic device of claim 1, wherein when executed by the at least one processor individually or collectively, further cause the electronic device to, based on receiving a communication establishment request from another device that is different from the determined external device, restrict establishing communication with the other device.

11. A method, performed by an electronic device, the method comprising:
determining, using a vision sensor, a reference distance between an external device and the electronic device, based on detecting the external device in a viewing region of a user for a threshold time;
determining, based on a category of the external device, at least one candidate device from among devices capable of establishing communication with the electronic device;
determining, for each of the at least one determined candidate device, a candidate distance between a corresponding candidate device and the electronic device using ranging of a communication module between a corresponding candidate device and the electronic device;
determining, based on a difference between the reference distance and each candidate distance, the external device from among the at least one candidate device; and
establishing communication with the external device using a device identifier of the external device, which is received from the determined external device.

12. The method of claim 11, wherein the determining of the at least one candidate device comprises determining the category of the external device based on information collected from the vision sensor.

13. The method of claim 12, further comprising:
determining, using the vision sensor, a gaze vector of the user for the viewing region; and
determining, for each of the at least one candidate device, a candidate vector from the electronic device to a corresponding candidate device, using the communication module,
wherein the determining of the external device comprises determining, based on a difference between the gaze vector and each candidate vector, the external device from among the at least one candidate device.

14. The method of claim 13, wherein the determining of the at least one candidate device comprises determining, based on the category of the external device, whether the electronic device operates as a central device or operates as a peripheral device in a discovery operation.

15. The method of claim 11, further comprising:
receiving category information of a corresponding device from each of the devices capable of establishing communication with the electronic device; and
determining the at least one candidate device based on the received category information.

16. The method of claim 11, further comprising:
receiving an authentication request for the user from the external device;
performing user authentication using user information collected by the electronic device; and
transmitting a result of the user authentication to the external device.

17. The method of claim 12, further comprising:
calculating, based on the information collected from the vision sensor, a possibility score that each of a plurality of categories is the category of the external device; and
determining the external device from among the at least one candidate device based on the calculated possibility score.

18. The method of claim 11, further comprising:
based on a plurality of communication modules of the communication module being available for ranging between the electronic device and a candidate device, determining a target communication module from among the plurality of communication modules, according to a priority based on at least one of accuracy or power consumption of ranging using the plurality of communication modules; and
determining a candidate distance between the electronic device and the candidate device, using ranging between the electronic device and the candidate device via the determined target communication module.

19. One or more non-transitory computer-readable storage media storing one or more computer programs including computer-executable instructions that, when executed by one or more processors of an electronic device individually or collectively, cause the electronic device to perform operations, the operations comprising:
determining, using a vision sensor, a reference distance between an external device and the electronic device, based on detecting the external device in a viewing region of a user for a threshold time;
determining, based on a category of the external device, at least one candidate device from among devices capable of establishing communication with the electronic device;
determining, for each of the at least one determined candidate device, a candidate distance between a corresponding candidate device and the electronic device using ranging of a communication module between a corresponding candidate device and the electronic device;
determining, based on a difference between the reference distance and each candidate distance, the external device from among the at least one candidate device; and
establishing communication with the external device using a device identifier of the external device, which is received from the determined external device.

20. The one or more non-transitory computer-readable storage media of claim 19, wherein the determining of the at least one candidate device comprises determining the category of the external device based on information collected from the vision sensor.
